(19) United States
(12) Patent Application Publication
(10) Pub. No.: US 2018/0023615 A1
(43) Pub. Date: Jan. 25, 2018

(54) FEMALE THREADED BODY, AND THREADED BODY FASTENING STRUCTURE

(71) Applicant: NejiLaw inc., Tokyo (JP)

(72) Inventor: Hiroshi Michiwaki, Tokyo (JP)

(21) Appl. No.: 15/534,947

(22) PCT Filed: Dec. 10, 2015
(86) PCT No.: PCT/JP2015/084627

§ 371 Date: Jun. 9, 2017

(30) Foreign Application Priority Data
Dec. 10, 2014 (JP) 2014-249850
Dec. 10, 2014 (JP) 2014-249851

(51) Int. Cl. F16B 39/286; F16B 37/00

(52) U.S. Cl. CPC F16B 39/286; F16B 37/00

(57) ABSTRACT

A female threaded body (100) is provided with: a female threaded helical structure (114) formed on the inner circumferential surface of a hole (106a) in a cylindrical member (106); a contact surface (110a) formed on an axial direction end face of said cylindrical member (106); and a reverse rotation-preventing member (160), which has a protruding section (168) that is disposed and fixed on said contact surface (110a) and protrudes radially inward toward the rotation axis and in which the tip of said protruding section (168) configures an engaging edge (168a) that forms a continuous or discontinuous helix of a different lead angle and/or lead direction from the lead angle and/or lead direction of the female threaded helical structure (114). The engaging edge (168a) may allow a relative rotation of a male thread body (10) and the female threaded helical structure (114) in one direction.

### TECHNICAL FIELD

Example embodiments relate to a female threaded body relates to a female threaded body and a thread body fastening structure.

### BACKGROUND ART

A male threaded body such as a bolt and a female threaded body such as a nut may be used as a fastening structure. In such a fastening structure, two types of helical grooves with different lead angles and/or lead directions, for example, a right-handed male threaded portion and a left-handed male threaded portion, may be formed for a single male threaded body. In addition, two types of the female threaded body such as a double nut, for example, a right-handed female threaded portion and a left-handed female threaded portion, may be screwed with the two types of the helical grooves, respectively. Here, by preventing a relative rotation of the two types of the female threaded body using an engaging element, an axial interference action or an axial separation and returning action by the different lead angles and/or lead directions may suspend a mechanical release from the male threaded body (refer to Japanese Patent Publication No. 5406168).

Further, as another application, two types of female threaded helices with different lead angles and/or lead directions may also be formed for a single female threaded body (refer to Claims 15 through 19 and FIGS. 41 through 43 of Japanese Patent Publication No. 5406168). In such an application, to allow a relative rotation of the female threaded body and the male threaded body, which is limited to a fastening direction, one female threaded helix may be provided as a plate-type member to be elastically deformable.

### DISCLOSURE

### Technical Goals

According to example embodiments described herein, by providing a single female threaded body having two types of female threaded helices with different lead angles and/or lead directions, a mass-production of the female threaded body may be enabled. To meet a large demand, it may be needed to produce the female threaded body at a low cost and in large quantities, and also to form the two types of the female threaded helices of the female threaded body with a high precision.

In addition, when fastening the single female threaded body having the two types of the female threaded helices with different lead angles and/or lead directions, one female threaded helix may need to proceed helically towards a male threaded body, while a plate-type member of the other female threaded helix may need to be elastically deformed repetitively, to sequentially pass or surmount threads of the male threaded body in an axial direction. However, in some cases, a fastening target body, or a body to be fastened by the female threaded body and the male threaded body, may be fastened immediately before the one female threaded helix passes a next thread, and a rotation of the female threaded body may be suspended. In such cases, a mechanical release may be suspended using a last thread that is immediately passed. However, before the mechanical release is suspended, the female threaded body may be finely rotated in a reverse direction.

That is, as shown in an existing female threaded body, a fine reverse rotation along with the male threaded body using the other female threaded helix may be allowed during an interval between a point in time when the one female threaded helix of the female threaded body passed a current thread and a point in time when the one female threaded helix is to pass a next thread, and thus such a fine reverse rotation may deteriorate a fastening force of the fastening target body.

Therefore, considering issues discussed in the foregoing, an aspect of the present disclosure provides a single female threaded body having two types of female threaded structures with different lead angles and/or lead directions, the single female threaded body being of a high quality and to be mass produced. In addition, using the single female threaded body having the two types of the female threaded structures with the different lead angles and/or lead directions may enable retention of a high fastening force of a fastening target body, or a body to be fastened.

### Technical Solutions

According to an aspect of the present disclosure, there is provided a female threaded body including a female threaded helical structure formed on an inner circumferential surface of a hole of a cylindrical member and set at a lead angle and/or in a lead direction, a receiving portion including a contact surface formed on an end surface of the cylindrical member in an axial direction of the hole, and a reverse rotation-preventing member disposed on the contact surface and including a protruding portion extended in a radially inward direction towards an axis. A protruding end of the protruding portion may include a disconnected or connected helical engaging edge that is set at a lead angle and/or in a lead direction different from the lead angle and/or the lead direction of the female threaded helical structure. The engaging edge may be elastically deformed to rotate on a base end of the protruding portion as a supporting point in a direction in which the protruding end is separated from the contact surface, and be elastically deformed repetitively to helically proceed when being screwed with a male threaded body to allow a relative rotation of the female threaded helical structure in one direction and prevent a relative rotation in another direction.

The female threaded helical structure of the cylindrical member of the female threaded body may be screwed with one helical groove of the male threaded body having a multi-thread structure portion having a first helical groove set at a lead angle and/or in a lead direction and a second helical groove set at a lead angle and/or in a lead direction different from the lead angle and/or the lead direction of the first helical groove, which are formed on a same area by overlapping each other. In addition, while the cylindrical member is helically proceeding along the one helical groove of the male threaded body, the engaging edge of the female threaded body may come into contact with threads of the other helical groove between the first helical groove and the second helical groove of the male threaded body, and may be elastically deformed to rotate on a base end of the protruding portion as a supporting point in a direction in which the protruding end is separated from the contact surface and be elastically deformed repetitively to pass threads of the other helical groove in order to allow a relative rotation of the female threaded helical structure in one direction and prevent a relative rotation in another direction.

When observing the contact surface from a cross-sectional viewpoint in a direction perpendicular to the axis, a cross-sectional shape of the contact surface may be observed at a plurality of positions in a circumferential direction of the axis and/or the cross-sectional shape may be observed as being formed in an annular shape.

The receiving portion may include a first circumferential engaging portion, and the reverse rotation-preventing member may include a second circumferential engaging portion that is engaged with the first circumferential engaging portion in a circumferential direction. By the first circumferential engaging portion and the second circumferential engaging portion, the cylindrical member and the reverse rotation-preventing member may be fixed in the circumferential direction.

The receiving portion may include a first axial engaging portion, and the reverse rotation-preventing member may include a second axial engaging portion that is engaged with the first axial engaging portion in an axial direction. By the first axial engaging portion and the second axial engaging portion, the cylindrical member and the reverse rotation-preventing member may be fixed in the axial direction.

The first axial engaging portion may be engaged with the reverse rotation-preventing member in the axial direction by being bent when being assembled.

The first axial engaging portion may be formed along an outer circumference of the reverse rotation-preventing member.

The reverse rotation-preventing member may include a seating surface portion being in contact with the contact surface of the receiving portion in at least a circumferential direction in an angle range greater than or equal to 180°, and the engaging edge of the protruding portion may come into contact with the male threaded body in an angle range less than or equal to 360° in a circumferential direction.

The reverse rotation-preventing member may include the engaging edge in a range of less than 360° in a circumferential direction, which is provided as a plurality of engaging edges in the circumferential direction.

The reverse rotation-preventing member may include the seating surface portion being in contact with the contact surface of the receiving portion, and a standing portion extended from the seating surface portion in an axial direction, an extension distance in the axial direction gradually increasing in a circumferential direction. The protruding portion may be extended in a radially inward direction from the standing portion.

By applying a predetermined or higher torque in a releasing direction by setting an extension length, or a protruding length, of the protruding portion, setting a standing length of the standing portion, setting relative angles of the protruding portion and the standing portion, and the like, the protruding portion may be elastically deformed, and the female threaded body may be, relatively readily, detached from the male threaded body.

According to another aspect of the present disclosure, there is provided a female threaded body including a first female threaded helical structure formed on an inner circumferential surface of a hole of a cylindrical member and set at a lead angle and/or in a lead direction, a reverse rotation-preventing member disposed in the cylindrical member, including a protruding portion extended in a radially inward direction towards an axis, and configured to prevent a rotation by the first female threaded helical structure at a predetermined circumferential angle by a protruding end of the protruding portion, and a deformable tapered surface formed on an end surface on another side of the cylindrical member. The protruding portion may be elastically deformed when being in contact with a male threaded body to allow a relative rotation of the first female threaded helical structure and the male threaded body in one direction and prevent a relative rotation in another direction to control a reverse rotation. The protruding portion may be desirably disposed at one end of the cylindrical member.

In a case in which a lead of the first female threaded helical structure is referred to as L1 and the predetermined circumferential angle is referred to as θ, an axial displacement T by a deformation of the tapered surface may satisfy T≧L1×(θ/360).

According to still another aspect of the present disclosure, there is provided a female threaded body including a first female threaded helical structure formed on an inner circumferential surface of a hole of a cylindrical member and set at a lead angle and/or in a lead angle, a reverse rotation-preventing member disposed in the cylindrical member in an axial direction of the hole and including a protruding portion extended in a radially inward direction towards an axis, and a deformable tapered surface formed on an end surface of the cylindrical member. Here, a protruding end of the protruding portion may include an engaging edge of a disconnected or connected second female threaded helical structure set in a lead direction different from the lead direction of the first female threaded helical structure. The engaging edge may be elastically deformed to rotate on a base end of the protruding portion as a supporting point in a direction in which the protruding end is separated from a contact surface, and be elastically deformed repetitively to helically proceed when being screwed with a male threaded body to allow a relative rotation of the first female threaded helical structure in one direction and prevent a relative rotation in another direction. In a case in which a lead of the first female threaded helical structure is referred to as L1 and a lead of the second female threaded helical structure is referred to as L2, an axial displacement T by a deformation of the tapered surface may satisfy T≧(1/2)×{L1×L2/(L1+L2)}.

The axial displacement T by the deformation of the tapered surface may satisfy T≧{L1×L2/(L1+L2)}

According to yet another aspect of the present disclosure, there is provided a female threaded body including a first female threaded helical structure formed on an inner circumferential surface of a hole of a cylindrical member and set at a lead angle and/or in a lead direction, a reverse rotation-preventing member disposed in the cylindrical member and including a protruding portion extended in a radially inward direction towards an axis, and a deformable tapered surface formed on an end surface of the cylindrical member. Here, a protruding end of the protruding portion may include an engaging edge of a disconnected or connected second female threaded helical structure set in the same lead direction as the lead direction of the first female threaded helical structure and at a lead angle different from the lead angle of the first female threaded helical structure. The engaging edge may be elastically deformed to rotate on a base end of the protruding portion as a supporting point in a direction in which the protruding end is separated from a contact surface, and be elastically deformed repetitively to helically proceed when being screwed with a male threaded body to allow a relative rotation of the first female threaded helical structure in one direction and prevent a relative rotation in another direction. In a case in which a lead of the first female threaded helical structure is referred to as L1 and a lead of the second female threaded helical structure is referred to as L2, an axial displacement T by a deformation of the tapered surface may satisfy T≧(1/2)×{L1×L2/(L1−L2)}.

The axial displacement T by the deformation of the tapered surface may satisfy T≧{L1×L2/(L1−L2)}.

According to further another aspect of the present disclosure, there is provided a female threaded body including a first female threaded helical structure formed on an inner circumferential surface of a hole of a cylindrical member and set at a lead angle and/or in a lead direction, a reverse rotation-preventing member disposed in the cylindrical member and including a protruding portion extended in a radially inward direction towards an axis, and a deformable tapered surface formed on an end surface of the cylindrical member. Here, a protruding end of the protruding portion may include an engaging edge of a disconnected or connected second female threaded helical structure set in a lead direction different from the lead direction of the first female threaded helical structure. The engaging edge may be elastically deformed to rotate on a base end of the protruding portion as a supporting point in a direction in which the protruding end is separated from a contact surface, and be elastically deformed repetitively to helically proceed when being screwed with a male threaded body to allow a relative rotation of the first female threaded helical structure in one direction and prevent a relative rotation in another direction. In a case in which a lead of the first female threaded helical structure is referred to as L1 and a pitch of the second female threaded helical structure is referred to as P2, an axial displacement T by a deformation of the tapered surface may satisfy T≧(1/2)×{L1×P2/(L1+P2)}.

According to still another aspect of the present disclosure, there is provided a female threaded body including a first female threaded helical structure formed on an inner circumferential surface of a hole of a cylindrical member and set at a lead angle and/or in a lead direction, a reverse rotation-preventing member disposed in the cylindrical member and including a protruding portion extended in a radially inward direction towards an axis, and a deformable tapered surface formed on an end surface of the cylindrical member. Here, a protruding end of the protruding portion may include an engaging edge of a disconnected or connected second female threaded helical structure set in the same lead direction as the lead direction of the first female threaded helical structure and at a lead angle different from the lead angle of the first female threaded helical structure. The engaging edge may be elastically deformed to rotate on a base end of the protruding portion as a supporting point in a direction in which the protruding end is separated from a contact surface, and be elastically deformed repetitively to helically proceed when being screwed with a male threaded body to allow a relative rotation of the first female threaded helical structure in one direction and prevent a relative rotation in another direction. In a case in which a lead of the first female threaded helical structure is referred to as L1 and a pitch of the second female threaded helical structure is referred to as P2, an axial displacement T by a deformation of the tapered surface may satisfy T≧(1/2)×{L1×P2/(L1−P2)}.

According to still another aspect of the present disclosure, there is provided a threaded body fastening structure including a male threaded body, and a female threaded body to be screwed with the male threaded body. The male threaded body may include a head portion, and an axis portion including a first male threaded helical structure set at a lead angle and/or in a lead direction. The female threaded body may include a first female threaded helical structure formed on an inner circumferential surface of a hole of a cylindrical member and set at a lead angle and/or in a lead direction to be screwed with the first male threaded helical structure, and a reverse rotation-preventing member disposed in the cylindrical member, including a protruding portion extended in a radially inward direction towards an axis, and configured to prevent a rotation by the first female threaded helical structure at a predetermined circumferential angle by a protruding end of the protruding portion. Here, a deformable tapered surface may be formed on an end surface of the head portion of the male threaded body and/or an end surface of the cylindrical member of the female threaded body. An engaging edge of the female threaded body may come into contact with the male threaded body and be elastically displaced to allow a relative rotation of the first male threaded helical structure and the first female threaded helical structure in one direction and prevent a relative rotation in another direction to control a reverse rotation.

According to still another aspect of the present disclosure, there is provided a threaded body fastening structure including a male threaded body, and a female threaded body to be screwed with the male threaded body. The male threaded body may include a head portion, and an axis portion including a first male threaded helical structure set at a lead angle and/or in a lead direction and a second male threaded helical structure set at a lead angle and/or in a lead direction different from the lead angle and/or the lead direction of the first male threaded helical structure. The female threaded body may include a first female threaded helical structure formed on an inner circumferential surface of a hole of a cylindrical member and to be screwed with the first male threaded helical structure, and a reverse rotation-preventing member disposed in the cylindrical member and including a protruding portion extended in a radially inward direction towards an axis. Here, a protruding end of the protruding portion may include an engaging edge of a second female threaded helical structure to be screwed, connectedly or disconnectedly, with the second male threaded helical structure. A deformable tapered surface may be formed on an end surface of the head portion of the male threaded body and/or an end surface of the cylindrical member of the female threaded body. The engaging edge of the female threaded body may be elastically deformed to rotate on a base end of the protruding portion as a supporting point in a direction in which the protruding end is separated from a contact surface, and be elastically deformed repetitively to helically proceed when being screwed with the male threaded body to allow a relative rotation of the first male threaded helical structure and the first female threaded helical structure in one direction and prevent a relative rotation in another direction.

### Advantageous Effects

According to example embodiments described herein, it is possible to mass produce a high-quality single female threaded body having two types of female threaded structures with different lead angles and/or lead directions. In addition, using the single female threaded body having the two types of the female threaded structures with the different lead angles and/or lead directions, it is possible to maintain a high fastening force of a fastening target body, or a body to be fastened.

### BRIEF DESCRIPTION OF DRAWINGS

FIG. 1 includes (A) illustrating a front view and (B) illustrating a top view of a fastening structure to which a female threaded body is applied according to a first example embodiment of the present disclosure.

FIG. 2 includes (A) illustrating a cross-sectional front view and (B) illustrating a cross-sectional side view of the fastening structure.

FIG. 3 includes (A) illustrating a top view, (B) illustrating a cross-sectional front view, and (C) illustrating a front view of the female threaded body.

FIG. 4 includes (A) illustrating a top view, (B) illustrating a cross-sectional side view, (C) illustrating a side view, and (D) illustrating a cross-sectional partial view of the female threaded body.

FIG. 5 includes (A) illustrating a front view, (B) illustrating a cross-sectional view of threads, and (C) illustrating a top view of a male threaded body in the fastening structure.

FIG. 6 includes (A) illustrating a side view, (B) illustrating a cross-sectional view of threads, and (C) illustrating a top view of the male threaded body.

FIG. 7 includes (A) illustrating a cross-sectional front view in an initial state of a fastening action of the fastening structure, (B) illustrating a cross-sectional front view of the female threaded body being rotated by 90°, and (C) illustrating a cross-sectional front view of the female threaded body being rotated by 180°.

FIG. 8 is a cross-sectional front view of the female threaded body when being rotated in a releasing direction in which the female threaded body is released from the fastening structure.

FIG. 9 is a cross-sectional front view illustrating another configuration of the female threaded body.

FIG. 10 includes (A) illustrating a cross-sectional front view of another configuration of the female threaded body, and (B) and (C) illustrating front views of another configuration of the female threaded body.

FIG. 11 includes (A) illustrating a perspective view and (B) illustrating a cross-sectional front view of a female threaded body in another fastening structure.

FIG. 12 includes (A) illustrating a front view and (B) illustrating a top view of a fastening structure to which a female threaded body is applied according to a second example embodiment of the present disclosure.

FIG. 13 includes (A) illustrating a cross-sectional front view and (B) illustrating a cross-sectional side view of the fastening structure.

FIG. 14 includes (A) illustrating a top view, (B) illustrating a cross-sectional front view, and (C) illustrating a front view of the female threaded body.

FIG. 15 includes (A) illustrating a top view, (B) illustrating a cross-sectional side view, (C) illustrating a side view, and (D) illustrating a cross-sectional partial view of the female threaded body.

FIG. 16 includes (A) illustrating a front view, (B) illustrating a cross-sectional view of threads, and (C) illustrating a top view of a male threaded body in the fastening structure.

FIG. 17 includes (A) illustrating a side view, (B) illustrating a cross-sectional view of threads, and (C) illustrating a top view of the male threaded body.

FIG. 18 includes (A) illustrating a cross-sectional front view in an initial state of a fastening action of the fastening structure, (B) illustrating a cross-sectional front view of the female threaded body being rotated by 90°, and (C) illustrating a cross-sectional front view of the female threaded body being rotated by 180°.

FIG. 19 is a cross-sectional view of the female threaded body when being rotated in a releasing direction in which the female threaded body is released from the fastening structure.

FIG. 20 includes (A) illustrating a cross-sectional front view in an initial state of another fastening action of the fastening structure, (B) illustrating a cross-sectional front view of the female threaded body being rotated by 90°, and (C) illustrating a cross-sectional front view of the female threaded body being rotated by 180°.

FIG. 21 includes (A) illustrating an exploded view illustrating a state of threads of a male threaded portion of a male threaded body in the fastening structure, and (B) illustrating an exploded view illustrating a state of threads of a male threaded portion of a male threaded body in another fastening structure.

FIG. 22 is an exploded view illustrating a state of threads of a male threaded portion of a male threaded body in another fastening structure.

FIG. 23 is a cross-sectional front view illustrating another configuration of the female threaded body.

FIG. 24 includes (A) and (B) illustrating exploded views of a state of threads of a male threaded portion of a male threaded body in another fastening structure.

FIG. 25 is an exploded view illustrating a state of threads of a male threaded portion of a male threaded body in another fastening structure.

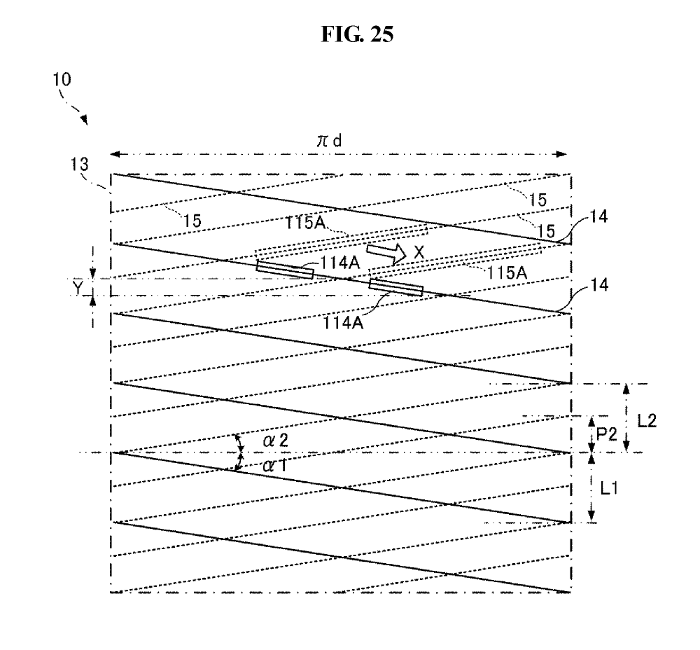

FIG. 26 includes (A) illustrating a cross-sectional front view of another configuration of the female threaded body, and (B) and (C) illustrating front views of the other configuration of the female threaded body.

FIG. 27 is a cross-sectional partial front view illustrating a configuration of another fastening structure.

FIG. 28 includes (A) illustrating a top view, (B) illustrating a front view, and (C) illustrating a cross-sectional front view of a configuration of a female threaded body in another fastening structure.

FIG. 29 includes (A) illustrating a perspective view and (B) illustrating a cross-sectional front view of a configuration of a female threaded body in another fastening structure.

### BEST MODE FOR CARRYING OUT INVENTION

Hereinafter, a first example embodiment of the present disclosure will be described with reference to the accompanying drawings.

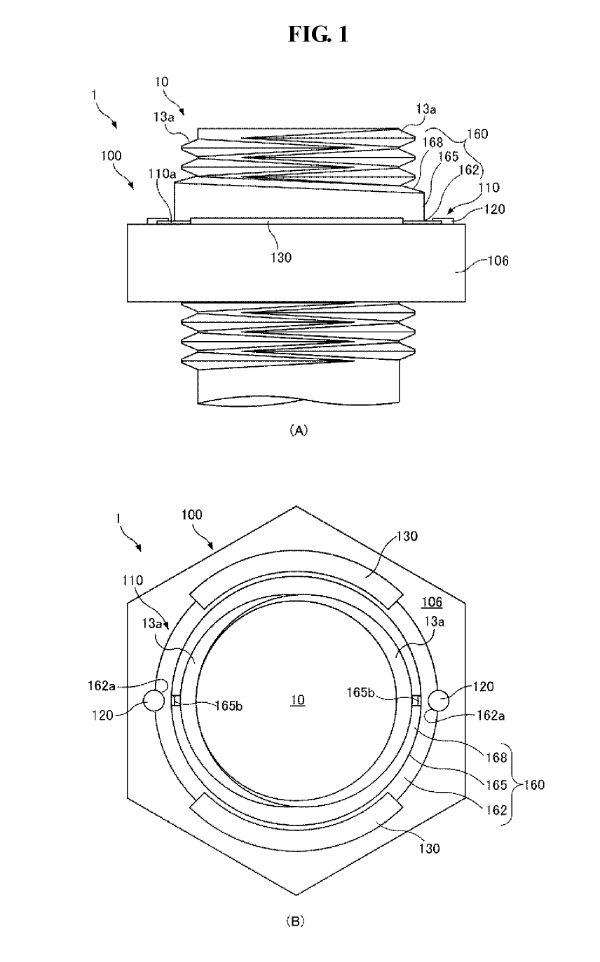

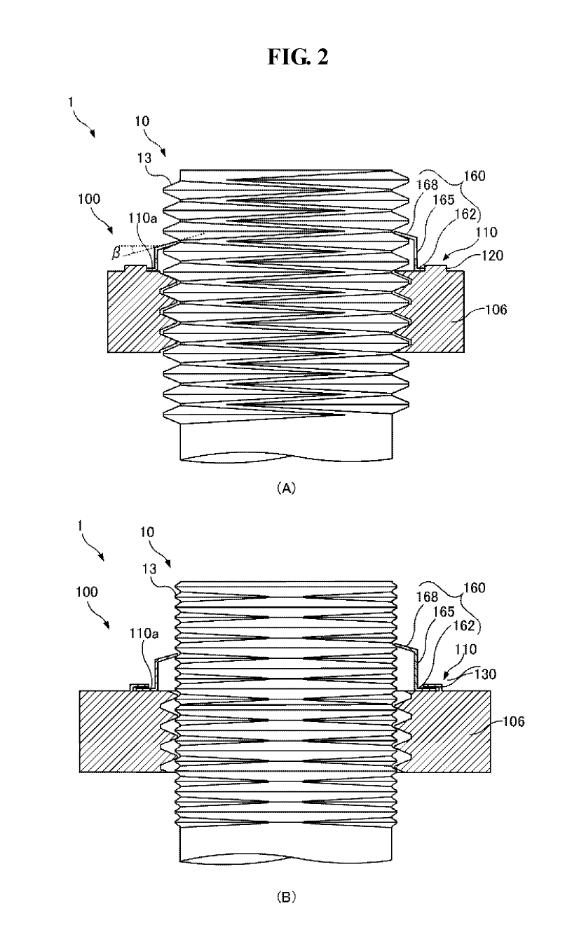

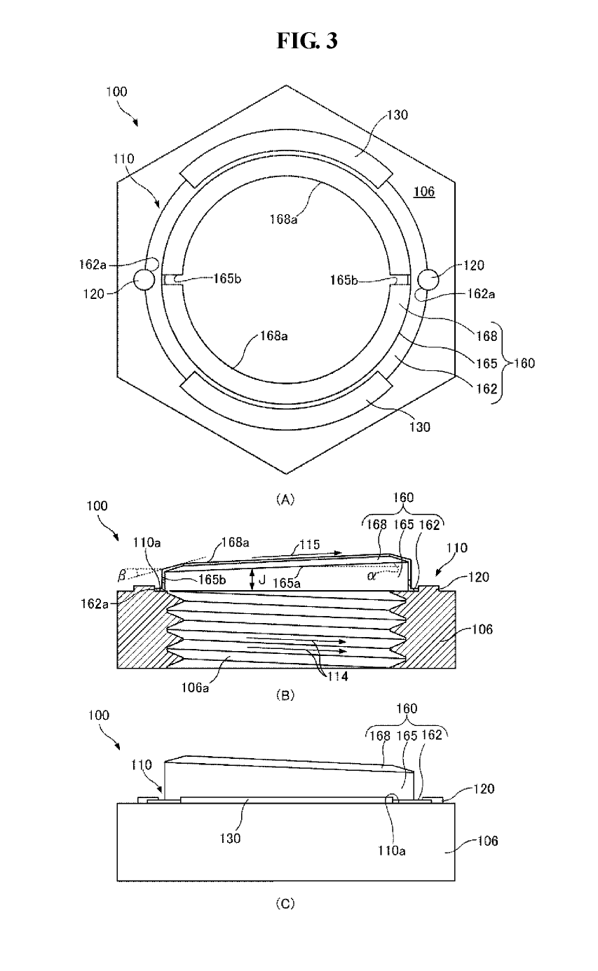

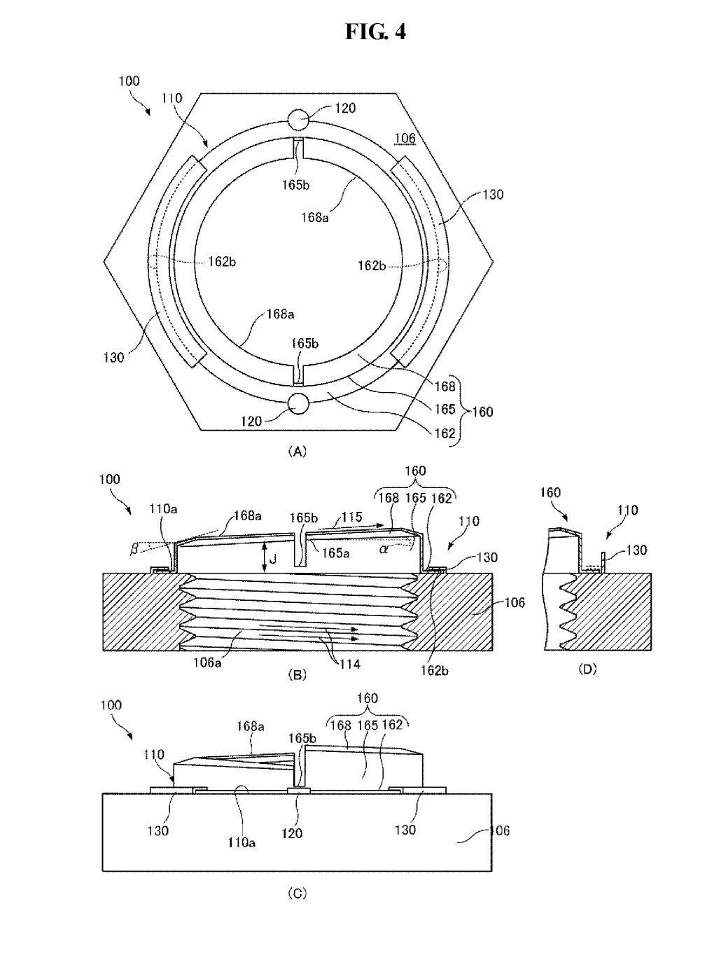

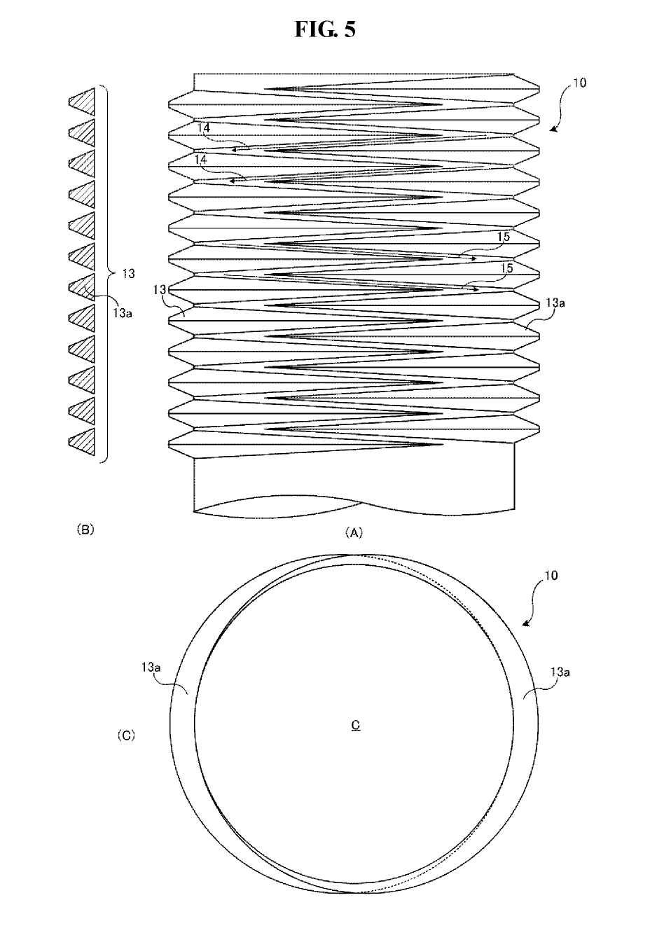

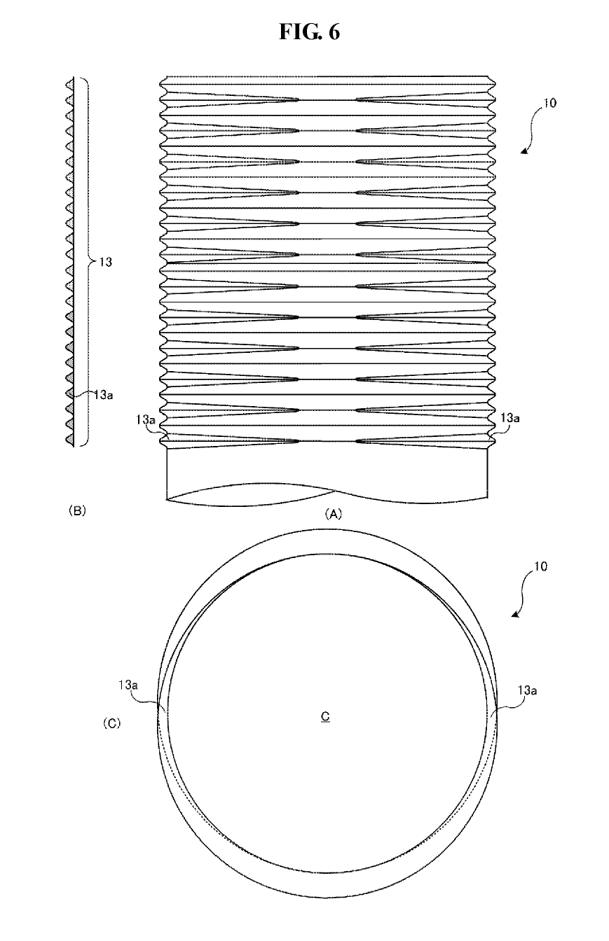

FIG. 1 includes a front view of a fastening structure 1 using a male threaded body 10 according to the first example embodiment of the present disclosure. FIG. 2 includes (A) illustrating a cross-sectional front view and (B) illustrating a cross-sectional side view of the fastening structure 1. FIG. 3 includes a cross-sectional view of a female threaded body 100 of the fastening structure 1. FIG. 4 includes a cross-sectional side view of the female threaded body 100. FIG. 5 includes an enlarged front view of the male threaded body 10, and FIG. 6 includes an enlarged side view of the male threaded body 10. As illustrated in the drawings, the fastening structure 1 is a structure in which the female threaded body 100 is fastened to the male threaded body 10. The female threaded body 100 may prevent a relative rotation of the male threaded body 10 in a releasing direction by a cylindrical member 106 and a reverse rotation-preventing member 160.

As illustrated in FIGS. 5 and 6, the male threaded body 10 is towards an axis end from a base portion, and includes a male threaded portion 13 including a male threaded helical structure. According to this example embodiment, the male threaded helical structure provided in two types—a first male threaded helical structure 14 including right-handed threads to be screwed with a female threaded helix provided as a corresponding right threads, and a second male threaded helical structure 15 including left-handed threads to be screwed with a female threaded helix provided as corresponding left threads—is formed, by overlapping each other, in a same area of the male threaded portion 13.

As illustrated in FIG. 5(C), the male threaded portion 13 includes a crescent-shaped thread 13a extended in a circumferential direction from a surface direction perpendicular to an axial core, for example, a thread axis C, which is provided as a plurality of threads 13a disposed alternately in one side (for example, a left side of the drawing) and the other side (for example, a right side of the drawing). By providing the threads 13a as illustrated, two types of helical grooves including a helical structure rotating right as illustrated by an arrow 14 in FIG. 5(A) and a helical structure rotating left as illustrated by an arrow 15 in FIG. 5(A) are formed between the threads 13a.

As described, the male threaded portion 13 includes the two types of the male threaded helical structure—the first male threaded helical structure 14 and the second male threaded helical structure 15. Thus, the male threaded potion 13 may be screwed with a female threaded body of any one of right-handed threads and left-handed threads. For a detailed description of the male threaded portion 13 including the two types of the male threaded helical structure, reference may be made to Japanese Patent Publication No. 4663813 related to the inventor(s) of the present disclosure.

As illustrated in FIGS. 3 and 4, the female threaded body 100 includes the cylindrical member 106 and the reverse rotation-preventing member 160. The cylindrical member 106 is provided in a hexagonal nut form, and includes a hollow penetration potion 106a at a center thereof. Here, an overall form of the female threaded body 100 is not limited to the hexagonal nut form, and may be set to be an any suitable form, for example, a cylindrical form, a form having a knurling portion on a circumferential surface, a tetragonal form, and a molded form. In the hollow penetration portion 106a, a first female threaded helical structure 114 is formed as right-handed threads. That is, the first female threaded helical structure 114 of the cylindrical member 106 is to be screwed with the first male threaded helical structure 14 of the male threaded portion 13 of the male threaded body 10.

The cylindrical member 106 includes a receiving portion 110. The receiving portion 110 is formed on an axial end surface of the cylindrical member 106, and includes a contact surface 110a that is nearly, or not necessarily, perpendicular to a rotation axis. The contact surface 110a is a ring-shaped flat surface and comes into contact with a seating surface portion 162 of the reverse rotation-preventing member 160, and receives the reverse rotation-preventing member 160 in an axial direction. It is also possible to form the ring-shaped contact surface 110a to be included in the axial end surface.

In addition, the receiving portion 110 includes a first circumferential engaging portion 120 and a first axial engaging portion 130. As illustrated in FIG. 3(A), the first circumferential engaging portion 120 is a protrusion that protrudes in an axial direction with respect to the contact surface 110a, and the first circumferential engaging portion 120 is provided as two first circumferential engaging portions 120 disposed at an interval of 180° in a circumferential direction. The first circumferential engaging portion 120 may be provided as a plurality of first circumferential engaging portions 120, which is separated from one another in the circumferential direction, although not necessarily provided as described. The first circumferential engaging portion 120 is engaged with a second circumferential engaging portion 162a of the reverse rotation-preventing member 160 to be engaged in a circumferential direction to control a relative rotation in the circumferential direction. Although the first circumferential engaging portion 120 is illustrated here as protruding from the contact surface 110a, the first circumferential engaging portion 120 may be provided in a recessed form. Alternatively, the first circumferential engaging portion 120 may be provided in a convex or concave form in an axial direction. For example, it may also be desirable to form a concavo-convex portion, for example, a radial groove, on the contact surface 110a through an embossing or knurling process.

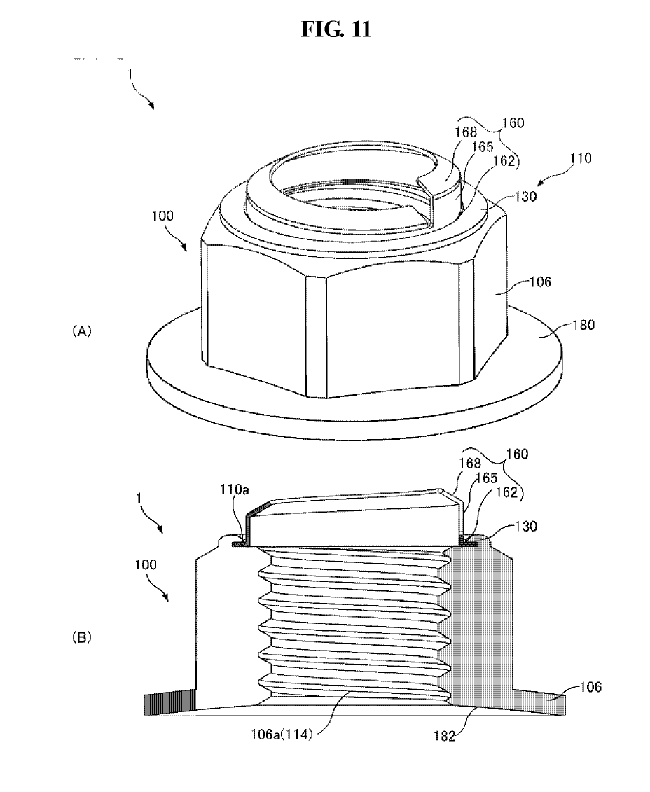

As illustrated in FIG. 4(B), the first axial engaging portion 130 is disposed opposite to the contact surface 110a with a fine gap therebetween. The gap is disposed to allow the plate-type seating surface portion 162 of the reverse rotation-preventing member 160, for example, a second axial engaging portion 162b, to be interposed therein. The contact surface 110a and the first axial engaging portion 130 are formed to support together the seating surface portion 162, and the first axial engaging portion 130 is engaged with the second circumferential engaging portion 162a in an axial direction. In addition, as illustrated in FIG. 4(D), the first axial engaging portion 130 is a circumferential wall-formed portion that is extended nearly perpendicular to the receiving portion 110a before being assembled, and the circumferential wall-formed portion stands in a circumferential direction along an outer circumference of the seating surface portion 162 of the reverse rotation-preventing member 160. As indicated by a broken line, when being assembled, after the reverse rotation-preventing member 160 is disposed, the first axial engaging portion 130 is bent in a radially inward direction, and the first axial engaging portion 130 and the reverse rotation-preventing member 160 are caulked to be fastened together in an axial direction. Although the first axial engaging portion 130 is illustrated as two circumferential wall-formed portions in a range of approximately 90° in a circumferential direction, it may also be desirable to dispose the first axial engaging portion 130 in all directions, for example, 360°, and dispose disconnected circumferential wall-formed portions in all directions, as illustrated in FIG. 11.

Hereinafter, the reverse rotation-preventing member 160 will be described in greater detail. The reverse rotation-preventing member 160 includes the seating surface portion 162, a standing portion 165, and a protruding portion 168. As illustrated in FIG. 4(A), the seating surface portion 162 is provided as a ring-shaped plate portion being in contact with the contact surface 110a of the receiving portion 110, and a portion and/or entirety thereof is included in the second axial engaging portion 162b. The second axial engaging portion 162b is engaged together with, or overlaps, the first axial engaging portion 130 in an axial direction. The seating surface portion 162 comes into contact with the contact surface 110a of the receiving portion 110 in an angle range, desirably, greater than or equal to 180° in a circumferential direction, for example, 360°, to stabilize a posture of a reverse rotation-preventing structure and also maintain a state of being engaged with the first axial engaging portion 130.

The second circumferential engaging portion 162a is formed on an outer circumference of the seating surface portion 162. The second circumferential engaging portion 162a includes a concave cut portion that is displaced in a radially inward direction of the outer circumference of the seating surface portion 162, and is engaged with the first circumferential engaging portion 120 of the receiving portion 110 in a circumferential direction. Although the concave cut portion that is recessed in the radially inward direction is illustrated as an example, it may also be desirable to form, not necessarily, a protrusion that is convex in a radially outward direction, or a concave or convex form in an axial direction. It may also be desirable to form a concavo-convex form, for example, a radial groove, on a flat surface of the seating surface portion 162 that faces the contact surface 110a through an embossing or knurling process, as an example of the second circumferential engaging portion 162a provided in the concave or convex form in the axial direction.

As illustrated in FIG. 4(B), the standing portion 165 is nearly a cylindrical portion extended from the seating surface portion 162 in an axial direction. An extension distance J in the axial direction may gradually increase or decrease in a circumferential direction. Thus, an end edge 165a of the standing portion 165 on an opposite side to the seating surface potion 162 is inclined with respect to the seating surface portion 162, and an inclination angle α of such an inclination is set to correspond to a lead angle of the second male threaded helical structure 15. That is, the end edge 165a becomes a helix extended in a range of approximately 360° in a circumferential direction. It may also be desirable to form an axial cut portion 165b in the standing portion 165, and such a formation may degrade rigidity in a radial direction, and thus allow the standing portion 165 to be elastically deformed, more readily, in a radially outward direction. Although the cut portion 165b is illustrated as being formed at two positions in a circumferential direction, it may also be desirable to form the cut portion 165b at one position or at least three positions, or it may also be possible to form none cut portion 165b.

The protruding portion 168 is provided as a plate portion that protrudes in a radially inward direction from the end edge 165a of the standing portion 165. As illustrated in FIG. 3(A), the protruding portion 168 is provided as two partially circular arc-shaped plate portions in an angle range of approximately 180° or less, which are separated from two positions in a circumferential direction by a concave slit that is extended by the cut portion 165b of the standing portion 165 or formed by being cut in a radially outward direction from an end portion of the protruding portion 168. A plurality of engaging edges 168a is formed by a protruding end, which is an inner side in a radial direction of each protruding portion 168. Thus, each of the engaging edges 168a is a partially circular arc in an angle range of 180° or less in a circumferential direction, and comes into contact with an outer circumference of the male threaded body 10. Thus, by forming a circumferential distance of each engaging edge 168a to be less than or equal to 180°, a displacement in a radially outward direction may be more readily enabled. In addition, a diameter of the engaging edge 168a may almost coincide with a curvature of the second male threaded helical structure 15 of the male threaded body 10.

In addition, the protruding portion 168 is inclined, along a radial direction, in a direction in which an inner side of the protruding portion 168 is separated farther apart from a virtual plane formed by the seating surface portion 162. An inclination angle β in this radial direction almost coincides with a flank angle of a screw thread 13a of the second male threaded helical structure 15 of the male threaded body 10, which is set to be approximately 30° herein. The engaging edge 168a is formed along an inclination angle α of the end edge 165a of the standing portion 165, and the second female threaded helical structure 115 of left-handed threads with a lead angle α may be formed. The engaging edge 168a is screwed with the second male threaded helical structure 15 of the male threaded portion 13 in the male threaded body 10.

Hereinafter, an operation of the fastening structure 1 will be described in detail.

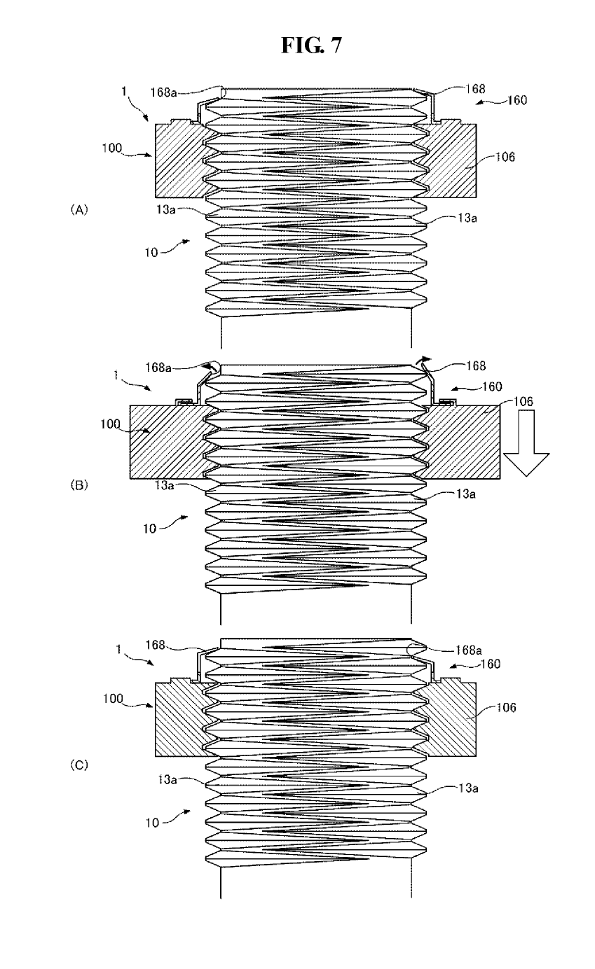

As illustrated in FIG. 7(A), while the first female threaded helical structure 114 of the cylindrical member 106 of the female threaded body 100 is being screwed with the first male threaded helical structure 14 of the male threaded body 10, the engaging edge 168a of the reverse rotation-preventing member 160 comes into contact with the second male threaded helical structure 15 of the male threaded body 10. However, since the female threaded body 100 is screwed based on the first female threaded helical structure 114 of the cylindrical member 106, the engaging edge 168a and the screw thread 13a of the second male threaded helical structure 15 enter an interference state while the cylindrical member 106 is proceeding helically.

As illustrated in FIG. 7(B), when the cylindrical member 106 is rotated by 90° and the first female threaded helical structure 114 is screwed with the first male threaded helical structure 14 in such a state, the cylindrical member 106 proceeds by ¼ pitch in a fastening direction, and the reverse rotation-preventing member 106 is forced to proceed in the fastening direction while being rotated in the same direction. Here, since the engaging edge 168a is inclined in a direction separated farther apart from the seating surface portion 162, the engaging edge 168a is elastically deformed, along a flank side of the screw thread 13a, in an axial direction and/or radially outward direction in which the engaging edge 168a is separated farther apart from the contact surface 110a, and is to pass the second male threaded helical structure 15. Here, it may be desirable to increase rigidity of an outer side of a radial direction by the standing portion 165, set an outwardly elastic deformation of the standing portion 165 to be small or approximately zero, and elastically deform the engaging edge 168a in an obtuse angle side with respect to the standing portion 165. While the cylindrical member 106 is being rotated by 180°, for example, 1/2 pitch, from the state illustrated in FIG. 7(A), the engaging edge 168a completely passes one screw thread 13a of the second male threaded helical structure 15 as illustrated in FIG. 7(C), and then is screwed with the second male threaded helical structure 15. By repeating such an operation, each time the female threaded body 100 is rotated by 180°, the engaging edge 168a passes the screw thread 13a of the second male threaded helical structure 15 and the female threaded body 100 is fastened to the male threaded body 10.

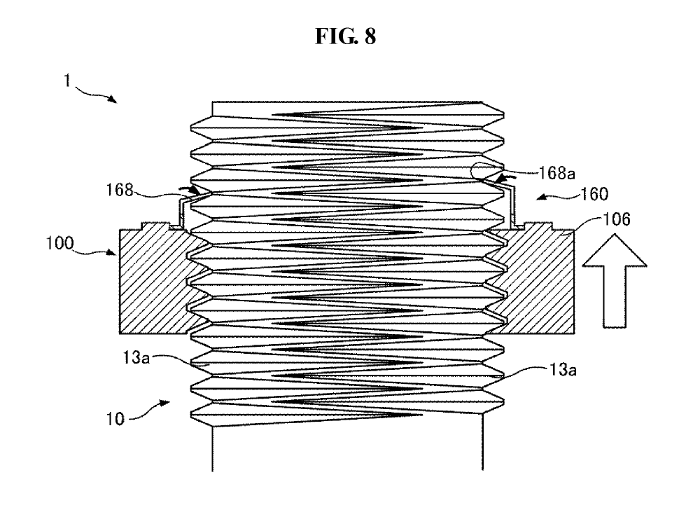

Referring to FIG. 8, under the assumption that the cylindrical member 106 of the female threaded body 100 is to be rotated in a releasing direction in which the cylindrical member 106 is released from the first male threaded helical structure 14 of the male threaded body 10, the protruding portion 168 forms an inclination such that a front end side, for example, a side of the engaging edge 168a, is separated from the virtual plane formed by the contact surface 110a, and such an inclination is set to correspond to, or desirably be contact with, a flank surface of the screw thread 13a of the second male threaded helical structure 15. In addition, a length from a base end of the protruding portion 168, for example, the end edge 165a of the standing portion 165, to a front end, for example, the engaging edge 168a, is set to correspond to, or desirably be equal to, a distance from a top to a bottom of the screw thread 13a. Thus, when a relative rotation in the releasing direction is applied to the cylindrical member 106 of the female threaded body 100, an inclined surface of the protruding portion 168 receives a force in a direction in which the inclined surface approaches the virtual plane formed by the contact surface 110a towards the standing portion 165, for example, in a direction in which the engaging edge 168a is closer to the contact surface 110a, and is elastically deformed. By increasing rigidity in a radially outward direction of the standing portion 165, the distance (e.g., a distance in a horizontal direction as illustrated in FIG. 8) in a virtual plane direction of the front end from the base end of the protruding portion 168 increases in response to the elastic deformation, and a valley of the screw thread 13a is narrowed by the engaging edge 168a, and thus the relative rotation in the releasing direction may be prevented mechanically and robustly. That is, the engaging edge 168a of the reverse rotation-preventing member 160 enters the valley of the screw thread 13a of the second male threaded helical structure 15, and then plays a role in controlling the relative rotation through crossing or conflicts of the progresses of the cylindrical member 106 and the reverse rotation-preventing member 160. Thus, the male threaded body 10 may not perform the relative rotation in the releasing direction. The reverse rotation-preventing member 160 allows a relative rotation along with the male threaded body 10 in one direction, for example, the fastening direction, by the first female threaded helical structure 114 of the cylindrical member 106, and suspends a reverse rotation completely. In addition, in the female threaded body 100, by setting an extension length or protruding length of the protruding portion 168, setting a standing length of the standing portion 165, and setting a relative angle between the protruding portion 168 and the standing portion 165, it is also possible to apply a predetermined or higher torque in the releasing direction, elastically deform the protruding portion 168, and separate the female threaded body 100 from the male threaded body 10, relatively readily.

In the female threaded body 100 according to this example embodiment, when observing the contact surface 110a of the receiving portion 110 from a cross-sectional viewpoint in a direction perpendicular to an axis, a cross-sectional shape of the contact surface 110a is observed at a plurality of positions in a circumferential direction and/or the cross-sectional shape is observed as being formed in an annular shape, or a ring shape. Thus, a posture of the reverse rotation-preventing member 160 being held and maintained by the contact surface 110a may become stable, and thus assembling may be performed more readily and also a precision in the assembling may be improved. In addition, according to this example embodiment, the cross-sectional shape of the contact surface 110a is formed as the annular shape, or the ring shape, and thus an optimally stable state may be obtained.

In addition, by forming an end surface of the cylindrical member 106 to be a flat surface, or a plane, on which the contact surface 110a is perpendicular to a rotation axis, it is possible to mass-produce the cylindrical member 106 simply as in a nut, when forming the cylindrical member 106 through pressing, cutting, rolling, heading, molding, shaping, and the like. In addition, to form the contact surface 110a to be inclined in a direction perpendicular to an axis and form a lead angle or a lead direction of the engaging edge 168a to be a slope in a set circumferential direction using such formed contact surface 110a, a production cost of the cylindrical member 106 may increase. In addition, when observing the contact surface 110a of such a slope type from a cross-sectional viewpoint in a direction perpendicular to an axis, a cross-sectional shape may be observed at only one position in a circumferential direction. In such a case, the posture of the reverse rotation-preventing member 160 being held and maintained by the contact surface 110a may not be stable, and also a force of sliding, along the slope, the reverse rotation-preventing member 160 in a circumferential direction may be generated. Thus, when assembling the cylindrical member 106 and the reverse rotation-preventing member 160, a high precision in determining a position may be needed.

In addition, according to this example embodiment, by the standing portion 165 with an axial-direction extension distance J that increases gradually in a circumferential direction, a lead direction and a lead angle of the second female threaded helical structure 115 is set. By employing such a structure, a mass production of the reverse rotation-preventing member 160 may be enabled and a production cost thereof may be reduced considerably using, for example, press molding using a plate-type member.

In the female threaded body 100, by the first circumferential engaging portion 120 of the cylindrical member 106 and the second circumferential engaging portion 162a of the reverse rotation-preventing member 160, the cylindrical member 106 and the reverse rotation-preventing member 160 may be fixed in a circumferential direction. Thus, it may be possible to control a relative rotation of the cylindrical member 106 and the reverse rotation-preventing member 160 even when being forced to be fastened while interfering with the engaging edge 168a of the reverse rotation-preventing member 160.

As described, by the first axial engaging portion 130 of the cylindrical member 106 and the second axial engaging portion 162b of the reverse rotation-preventing member 160, the cylindrical member 106 and the reverse rotation-preventing member 160 may be fixed in an axial direction. Thus, it may be possible to prevent the cylindrical member 106 and the reverse rotation-preventing member 160 from deviating in an axial direction even when the cylindrical member 106 is forcibly screwed and the engaging edge 168a of the reverse rotation-preventing member 160 is displaced in a radial direction. According to this example embodiment, a caulking may be performed by bending the first axial engaging portion 130 when assembling, and thus both—the reverse rotation-preventing member 160 and the first axial engaging portion 130—may be integrated with each other despite a simple and easy production process.

In particular, according to this example embodiment, the seating surface portion 162 of the reverse rotation preventing apparatus 160 is in contact with the contact surface 110a of the receiving portion 110 in an angle range of at least 180° or greater in a circumferential direction. Thus, by setting the seating surface portion 164 to be in an angle range of 180° or greater, a state of being engaged with the first axial engaging portion 130 may not be readily canceled even when an external force acts on the reverse rotation-preventing member 160. In addition, the engaging edge 168a of the reverse rotation-preventing member 160 is in contact with the male threaded body 10 in an angle range of 180° or less in a circumferential direction, and thus the engaging edge 168a of the reverse rotation-preventing member 160 may be, readily and flexibly, displaced in an axial direction and/or a radially outward direction. That is, by the reverse rotation-preventing member 160 according to this example embodiment, the reverse rotation-preventing member 160 may be completely integrated with the cylindrical member 106, and the engaging edge 168a may more readily displaced. Here, by disposing a plurality of engaging edges 168a in a circumferential direction, the engaging edges 168a may be completely engaged with the male threaded body 10 when the female threaded body 100 is rotated in a releasing direction, and such a rotation may be prevented. In addition, by setting an angle between the engaging edge 168a and the standing portion 165 to be an obtuse angle, the engaging edge 168a may be elastically deformed in an axial direction in which the engaging edge 168a is separated farther from the standing portion 165, for example, a direction in which the angle between the both is closer to 180°. However, such an elastic deformation in an axial direction in which the engaging edge 168a is closer to the standing portion 165, for example, a direction in which the angle between the both is closer to 90°, may not be easy.

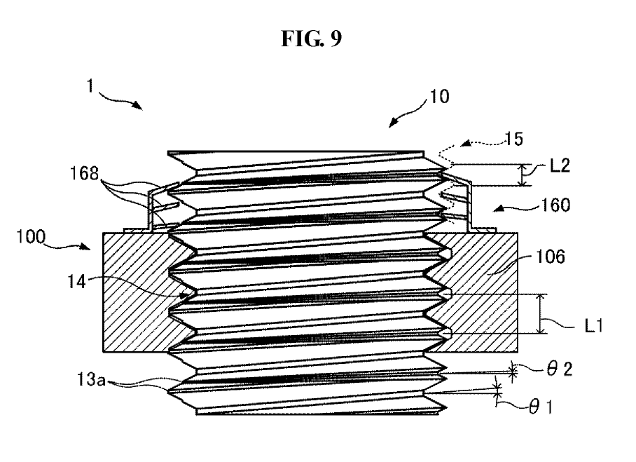

Although, in the male threaded body 10 and the female threaded body 100 according to this example embodiment, the first male threaded helical structure 14 and the first female threaded helical structure 114, and the second male threaded helical structure 15 and the second female threaded helical structure 115 are illustrated, respectively, as being in a reverse relationship having the same lead angle and opposite lead directions. However, example embodiments of the present disclosure are not limited to the example embodiment described in the foregoing. For example, as illustrated in FIG. 9, the first male threaded helical structure 14 and the first female threaded helical structure 114, and the second male threaded helical structure 15 and the second female threaded helical structure 115, which have the same lead direction and different lead angles, respectively, may also be employed. In such an example, by forming a threaded helix along with the helical screw thread 13a formed by the first male threaded helical structure 14, it is possible to align a thread direction of the first male threaded helical structure 14 with a lead L1 (lead angle of θ1) and the second male threaded helical structure 15 with a lead L2 (lead angle of θ2).

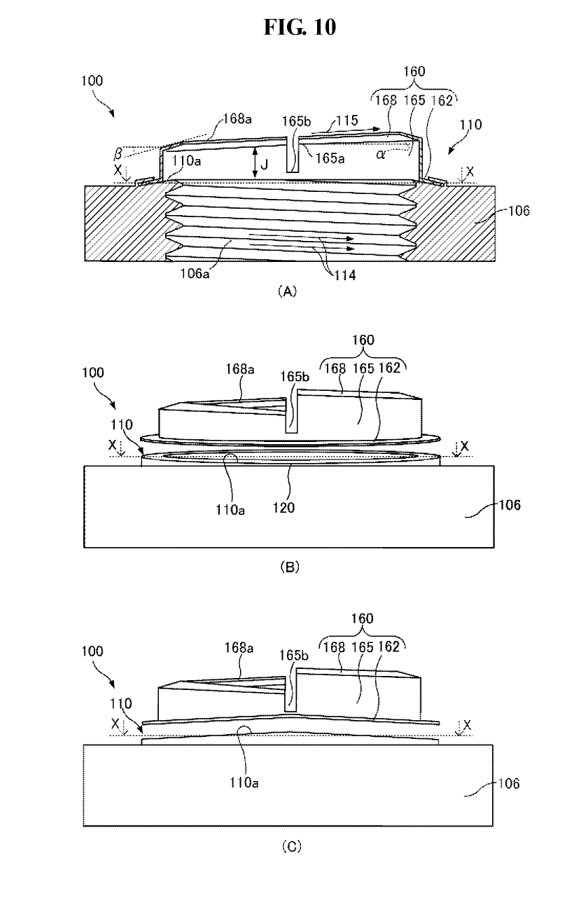

Although, in the female threaded body 100 according to this example embodiment, a cross-sectional shape of a range including the contact surface 110a, which is observed perpendicular to an axis, is illustrated as a planar ring shape that corresponds to the contact surface 110a, example embodiments of the present disclosure are not limited to the example described in the foregoing. For example, as shown in the female threaded body 100 illustrated in FIG. 10(A), the contact surface 110a is formed as a tapered surface that is inclined in a radial direction. In such an example, an X-X cross-sectional shape perpendicular to an axis is an annular line. For another example, as shown in the female threaded body 100 illustrated in FIG. 10(B), the contact surface 110a is formed as an inclined surface that is inclined in one direction with respect to the axis. In such an example, an X-X cross-sectional shape perpendicular to the axis is two linear portions. For still another example, as shown in the female threaded body 100 illustrated in FIG. 10(C), the contact surface 110a is formed as a pair of inclined surfaces that is inclined in one direction and the other direction with respect to the axis. In such an example, an X-X cross-sectional shape perpendicular to the axis is four linear portions. In any examples, a cross-sectional shape of the contact surface 110a may be obtained at a plurality of positions in a circumferential direction, when observed from a cross-sectional viewpoint perpendicular to the axis, and thus a posture of the reverse rotation-preventing member 160 being held and maintain may be stabilized.

Hereinafter, a second example embodiment of the present disclosure will be described with reference to the accompanying drawings.

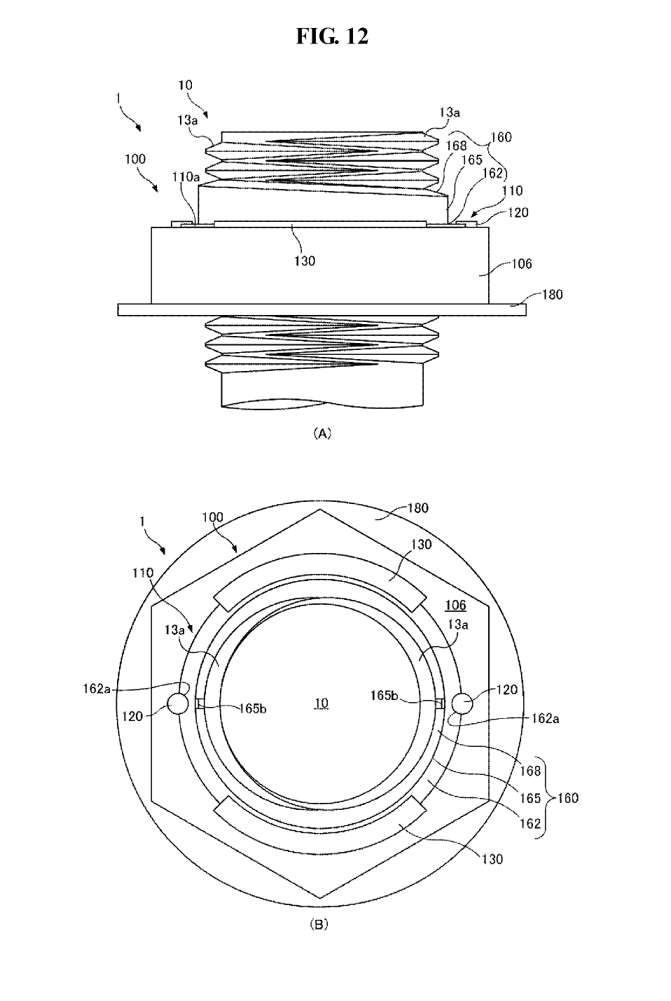

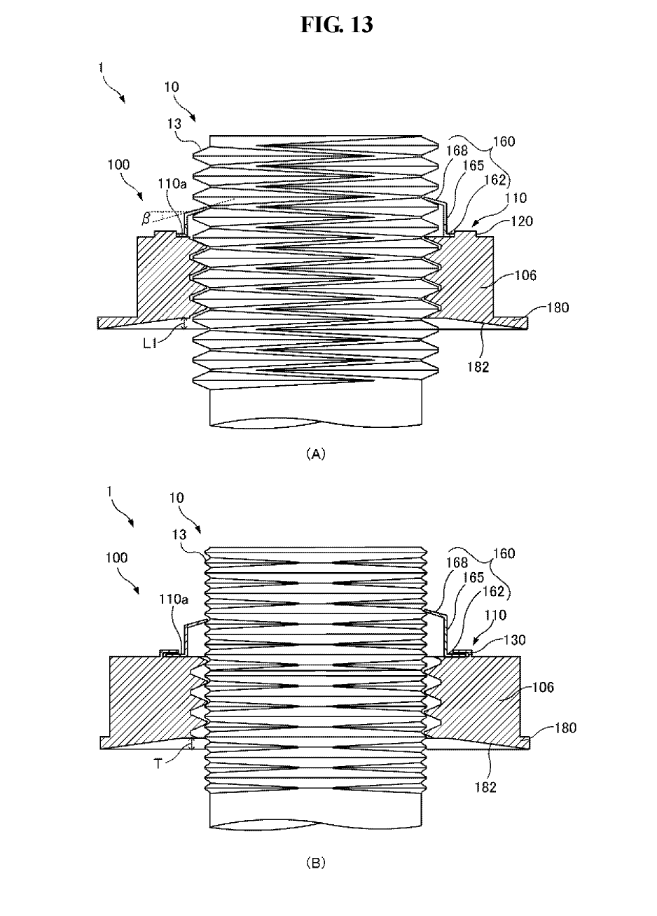

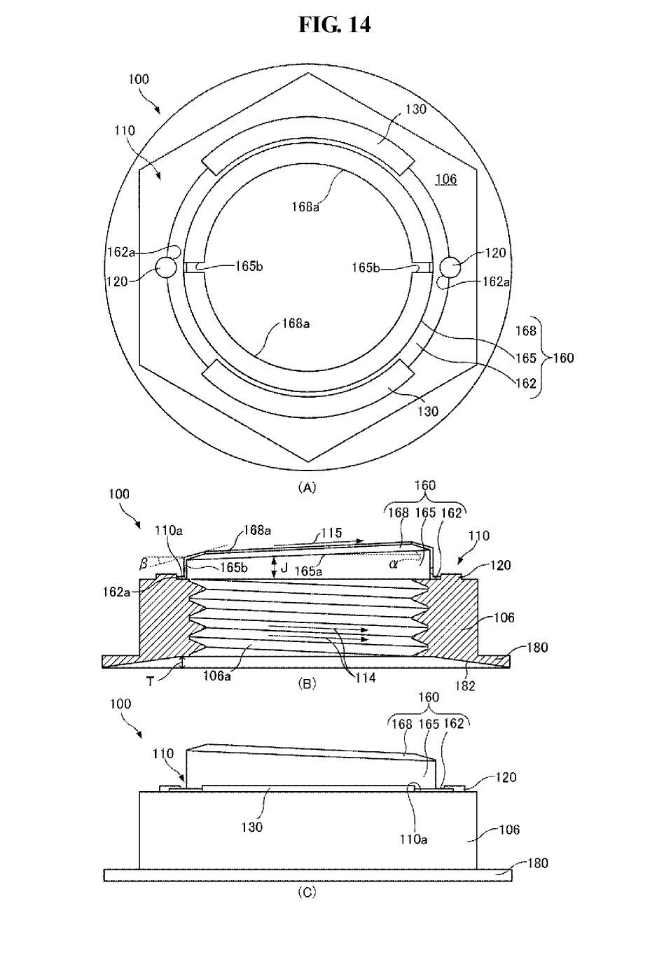

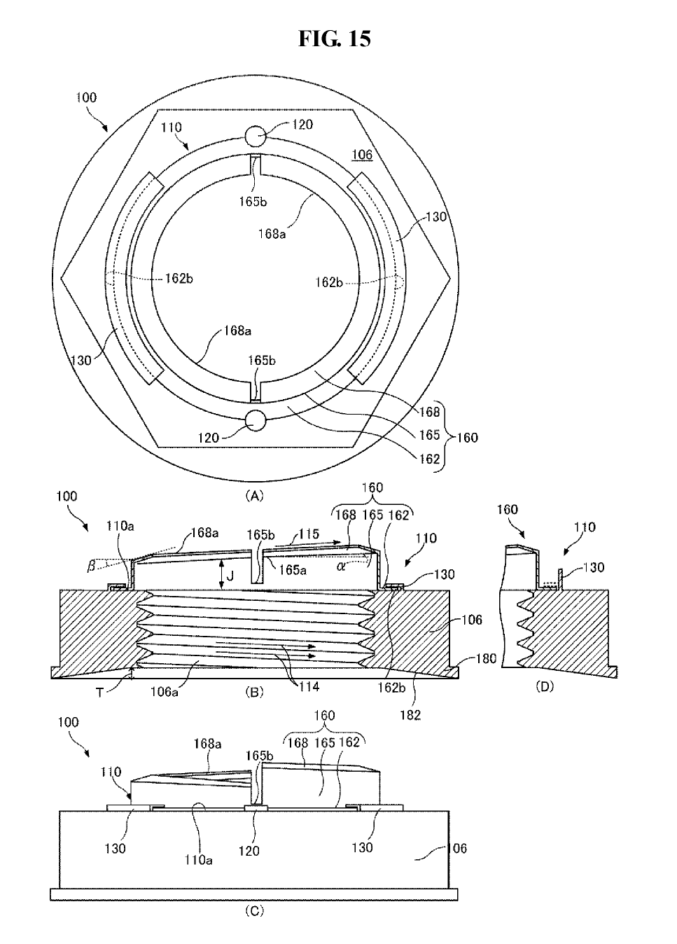

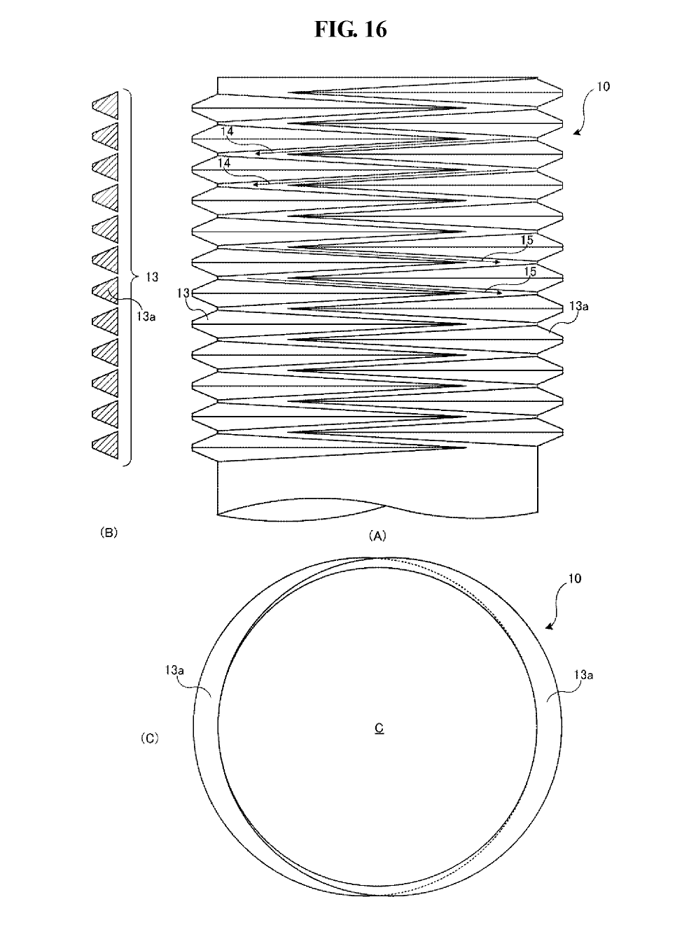

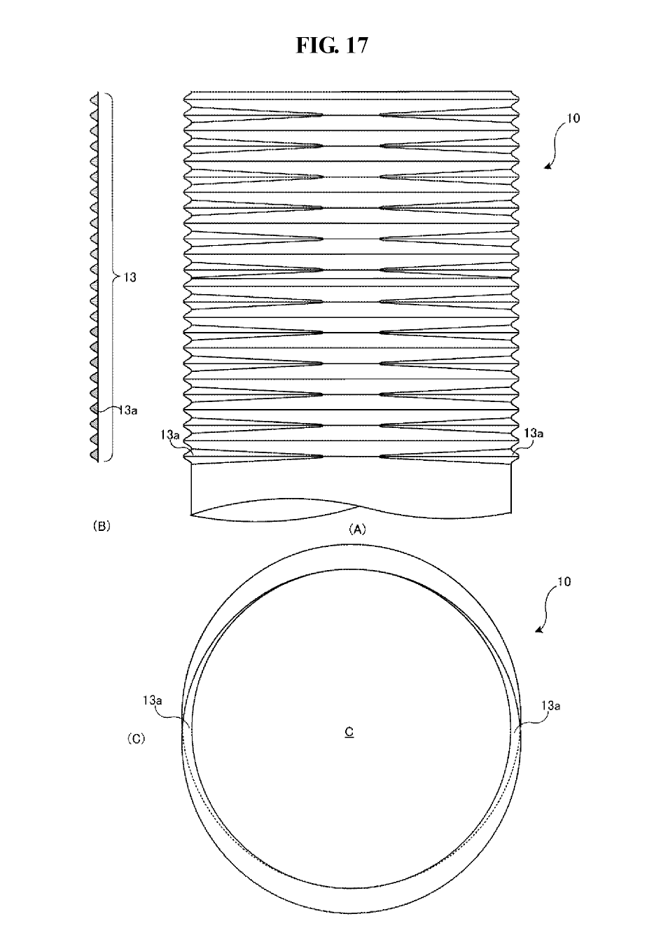

FIG. 12 includes a front view of a fastening structure 1 using a male threaded body 10. FIG. 13(A) is a cross-sectional front view of the fastening structure 1 and FIG. 13(B) is a cross-sectional side view of the fastening structure 1. FIG. 14 includes a cross-sectional front view a female threaded body 100, and FIG. 15 includes a cross-sectional side view of the female threaded body 100. FIG. 16 includes an enlarged front view of the male threaded body 10, and FIG. 17 includes an enlarged side view of the male threaded body 10. As illustrated in the drawings, the fastening structure 1 is formed by fastening the female threaded body 100 to the male threaded body 10. The female threaded body 100 may prevent a relative rotation of the male threaded body 10 in a releasing direction, using a cylindrical member 106 and a reverse rotation-preventing member 160.

As illustrated in FIGS. 16 and 17, the male threaded body 10 faces towards an axis end from a base portion, and includes a male threaded portion 13 including a male threaded helical structure. According to this example embodiment, in the male threaded portion 13, two types of the male threaded helical structure—a first male threaded helical structure 14 formed with right-handed threads configured to be screwed with a female threaded helix formed with corresponding right-handed threads, and a second male threaded helical structure 15 formed with left-handed threads configured to be screwed with a female threaded helix formed with corresponding left-handed threads—are formed in the same area in an overlapping manner.

As illustrated in FIG. 16(C), a nearly crescent-shaped screw thread 13a that is extendable in a circumferential direction with respect to a surface direction perpendicular to an axial center, or a thread axis C, is provided alternately on one side (left side of the drawing) and the other side (right side of the drawing) of the male threaded portion 13. By providing the screw thread 13a as illustrated, two types of thread grooves—a helical structure that turns right (refer to an arrow indicated by the reference numeral 14 in FIG. 16(A)) and a helical structure that turns left (refer to an arrow indicated by the reference numeral 15 in FIG. 16(A))—are formed between a plurality of screw threads 13a provided as the screw thread 13a.

According to this example embodiment, two types of male threaded helical structures—the first male threaded helical structure 14 and the second male threaded helical structure 15—are formed in the male threaded portion 13. Thus, the male threaded portion 13 may be screwed with any one of female threaded bodies of right-handed threads and left-handed threads. For a detailed description of the male threaded portion 13 including the two types of the male threaded helical structures, reference may be made to the patent publication no. 4663813 related to the inventor(s) of the present disclosure.

As illustrated in FIGS. 14 and 15, the female threaded body 100 includes the cylindrical member 106 and the reverse rotation-preventing member 160. The cylindrical member 106 is provided in, for example, a hexagonal nut form, and includes a hollow penetration portion 106a. A form of the female threaded body 100 is not limited to the illustrated hexagonal nut form, and may be set to be any suitable form, for example, a cylindrical form, a form having a knurling portion on a circumferential surface, a tetragonal form, and a molded form. In the hollow penetration portion 106a, a first female threaded helical structure 114 is formed as right-handed threads. That is, the first female threaded helical structure 114 of the cylindrical member 106 is to be screwed with the first male threaded helical structure 14 of the male threaded portion 13 of the male threaded body 10.

The cylindrical member 106 includes a rim portion 180 that is in proximity to an axial end portion and is extendable in a radially outward direction, and a tapered surface 182 on an end surface on a side on which the rim portion 180 is formed. The tapered surface 182 is provided in a conically trapezoidal form in which an inner side in a radial direction is recessed in an axial direction, and thus the tapered surface 182 is elastically deformed to be closer to a flat surface perpendicular to an axis when receiving a reaction force from a member to be fastened in response to a fastening force. Here, an axial displacement in the tapered surface 182 is defined as T.

The cylindrical member 106 includes a receiving portion 110. The receiving portion 110 is formed on an axial end surface on an opposite side to the tapered surface 182 of the cylindrical member 106, and includes a contact surface 110a that is nearly, although not necessarily, perpendicular to a rotation axis. The contact surface 110a is formed as a ring-shaped flat surface and comes into contact with a seating surface portion 162 of the reverse rotation-preventing member 160, and receives the reverse rotation-preventing member 160 in an axial direction. It is also possible to form the ring-shaped contact surface 110a to be included in the axial end surface.

In addition, the receiving portion 110 includes a first circumferential engaging portion 120 and a first axial engaging portion 130. As illustrated in FIG. 14(B), the first circumferential engaging portion 120 is a protrusion that protrudes in an axial direction with respect to the contact surface 110a, and two first circumferential engaging portions 120 are formed at a phase interval of 180° in a circumferential direction. The first circumferential engaging portion 120 may also be provided as a plurality of first circumferential engaging portions 120, which is separated from one another in a circumferential direction, although not necessarily provided as described, and also be provided as a single first circumferential engaging portion 120 in a circumferential direction. The first circumferential engaging portion 120 is engaged with a second circumferential engaging portion 162a of the reverse rotation-preventing member 160 to be engaged in the circumferential direction in order to control a relative rotation in a circumferential direction. Although the first circumferential engaging portion 120 is illustrated here as protruding from the contact surface 110a, the first circumferential engaging portion 120 may also be provided in a recessed form. Alternatively, the first circumferential engaging portion 120 may be provided in a convex or concave form in an axial direction. For example, it may also be desirable to form a concavo-convex portion, for example, a radial groove, on the contact surface 110a through an embossing or knurling process.

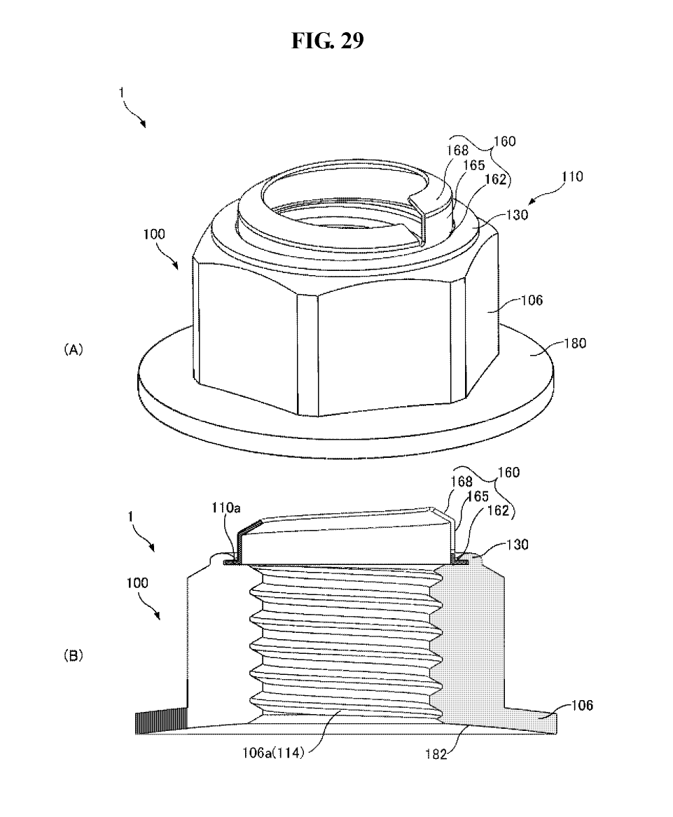

As illustrated in FIG. 15(B), the first axial engaging portion 130 is disposed to face the contact surface 110a with a fine gap therebetween. The gap is disposed to allow a plate-type seating surface portion 162 of the reverse rotation-preventing member 160, for example, a second axial engaging portion 162b, to be interposed therein. The contact surface 110a and the first axial engaging portion 130 are formed in a structure that supports, together, the seating surface portion 162, and the first axial engaging portion 130 is engaged with a second circumferential engaging portion 162a in an axial direction. In addition, as illustrated in FIG. 15(D), the first axial engaging portion 130 is a circumferential wall-formed portion that is extended nearly perpendicular to the receiving portion 110a before being assembled, and the circumferential wall-formed portion stands in a circumferential direction to be along an outer circumference of the seating surface portion 162 of the reverse rotation-preventing member 160. As indicated by a broken line, when being assembled after the reverse rotation-preventing member 160 is disposed, the first axial engaging portion 130 is bent in a radially inward direction and both are caulked to be fastened together in an axial direction. Although the first axial engaging portion 130 is illustrated as including two circumferential wall-formed portions in a range of approximately 90° in a circumferential direction, it may also be desirable to dispose them in all directions, for example, 360°, or dispose disconnected circumferential wall-formed portions in all directions, as illustrated in FIG. 29.

Hereinafter, the reverse rotation-preventing member 160 will be described in detail. The reverse rotation-preventing member 160 includes the seating surface portion 162, a standing portion 165, and a protruding portion 168.

As illustrated in FIG. 15(A), the seating surface portion 162 is provided as a ring-shaped plate portion to be in contact with the contact surface 110a of the receiving portion 110, and a portion and/or entirety thereof is included in the second axial engaging portion 162b. The second axial engaging portion 162b is engaged with the first axial engaging portion 130, or overlap, in an axial direction. The seating surface portion 162 comes into contact with the contact surface 110a of the receiving portion 110 in an angle range greater than or equal to 180° in a circumferential direction, for example, 360°, to stabilize a posture of a reverse rotation-preventing structure and also maintain a state of being engaged with the first axial engaging portion 130.

The second circumferential engaging portion 162a is formed on an outer circumference of the seating surface portion 162. The second circumferential engaging portion 162a includes a concave cut portion that is displaced in a radially inward direction of the outer circumference of the seating surface portion 162, and is engaged with the first circumferential engaging portion 120 of the receiving portion 110 in a circumferential direction. Although the concave cut portion that is recessed in the radially inward direction is illustrated as an example, it may also be desirable, although not necessarily, to form a protrusion that is convex in a radially outward direction, or a concave or convex form in an axial direction. It may also be desirable to form a concavo-convex form, for example, a radial groove, on a flat surface of the seating surface portion 162 that faces the contact surface 110a, as an example of the second circumferential engaging portion 162a provided in the concave or convex form in an axial direction, through an embossing or knurling process.

As illustrated in FIG. 15(B), the standing portion 165 is almost a cylindrical portion extended from the seating surface portion 162 in an axial direction. An extension distance J in the axial direction may gradually increase or decrease in a circumferential direction. Thus, an end edge 165a of the standing portion 165 on an opposite side to the seating surface potion 162 is inclined with respect to the seating surface portion 162, and an inclination angle α of such an inclination is set to correspond to a lead angle of the second male threaded helical structure 15. That is, the end edge 165a is a helix extended in a range of approximately 360° in a circumferential direction. It may also be desirable to form an axial cut portion 165b in the standing portion 165, and such a formation may degrade rigidity in a radial direction, and thus allow the standing portion 165 to be elastically deformed, more readily, in a radially outward direction. Although the cut portion 165b is illustrated as being formed at two positions in a circumferential direction, it may also be desirable to form the cut portion 165b at one position or at least three positions, or it may also be possible to form none cut portion 165b.

The protruding portion 168 is provided as a plate portion that protrudes in a radially inward direction from the end edge 165a of the standing portion 165. As illustrated in FIG. 14(A), the protruding portion 168 is provided as two partially circular arc-shaped plate portions in an angle range of approximately 180° or less, which are separated from two positions in a circumferential direction by a concave slit that is extended by the cut portion 165b of the standing portion 165 or formed by being cut in a radially outward direction from an end portion of the protruding portion 168. A radial-direction inner side of the protruding portion 168 is formed as a protruding end, by which a plurality of engaging edges 168a is formed. Thus, each of the engaging edges 168a is a partially circular arc in an angle range of 180° or less in a circumferential direction, and comes into contact with an outer circumference of the male threaded body 10. Thus, by setting a circumferential-direction distance of each engaging edge 168a to be less than or equal to 180°, a displacement in a radially outward direction may be more readily enabled. In addition, a diameter of the engaging edge 168a almost coincides with a curvature of the second male threaded helical structure 15 of the male threaded body 10.

In addition, the protruding portion 168 is inclined, along a radial direction, in a direction in which an inner side of the protruding portion 168 is separated farther apart from a virtual plane formed by the seating surface portion 162. An inclination angle β in this radial direction almost coincides with a flank angle of a screw thread 13a of the second male threaded helical structure 15 of the male threaded body 10, which is set to be approximately 30° herein. The engaging edge 168a is formed along an inclination angle α of the end edge 165a of the standing portion 165, and a second female threaded helical structure 115 of left-handed threads with a lead angle α is formed. The engaging edge 168a is screwed with the second male threaded helical structure 15 of the male threaded portion 13 of the male threaded body 10.

Hereinafter, an operation that is performed when a fastening target member 500, or a member to be fastened, is fastened by the fastening structure 1 will be described in detail.

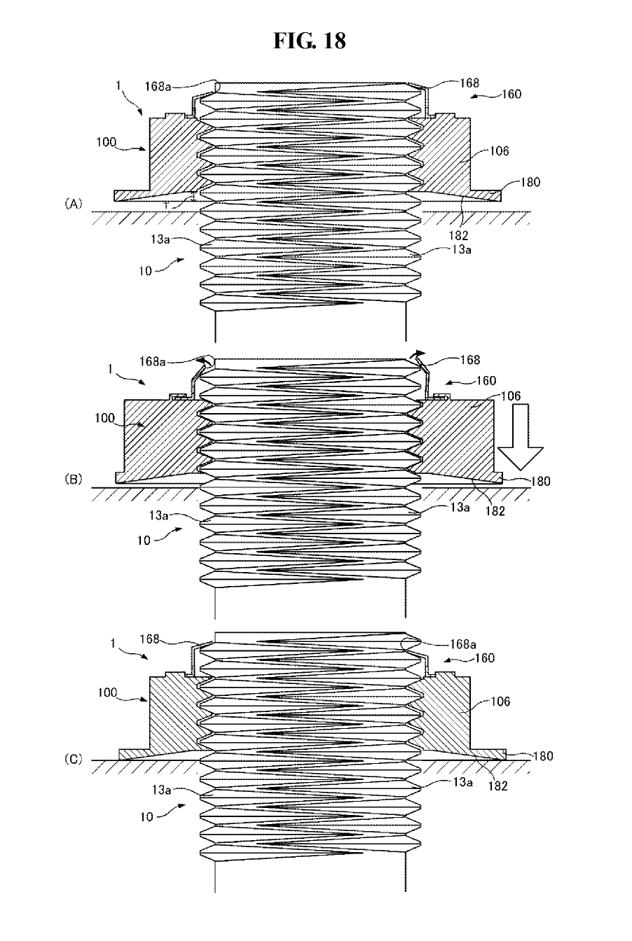

As illustrated in FIG. 18(A), while the first female threaded helical structure 114 of the cylindrical member 106 of the female threaded body 100 is being screwed with the first male threaded helical structure 14 of the male threaded body 10, the engaging edge 168a of the reverse rotation-preventing member 160 comes into contact with the second male threaded helical structure 15 of the male threaded body 10. However, since the female threaded body 100 is screwed based on the first female threaded helical structure 114 of the cylindrical member 106, the engaging edge 168a and the screw thread 13a of the second male threaded helical structure 15 come to an interference state while the cylindrical member 106 is proceeding helically.

As illustrated in FIG. 18(B), when the cylindrical member 106 is rotated by 90° and the first female threaded helical structure 114 is screwed with the first male threaded helical structure 14 in such a state, the cylindrical member 106 proceeds by ¼ pitch in a fastening direction, and the reverse rotation-preventing member 106 is forced to proceed in the fastening direction while being rotated in the same direction. Here, since the engaging edge 168a is inclined in a direction in which the engaging edge 168a is separated farther apart from the seating surface portion 162, the engaging edge 168a is elastically deformed, along a flank side of the screw thread 13a, in an axial direction and/or radially outward direction in which the engaging edge 168a is separated farther apart from the contact surface 110a, and is to pass the second male threaded helical structure 15. Here, it may be desirable to increase rigidity in a radially outward direction by the standing portion 165, set an outwardly elastic deformation of the standing portion 165 to be small or approximately zero, and to elastically deform the engaging edge 168a on an obtuse angle side with respect to the standing portion 165. While the cylindrical member 106 is being rotated by 180°, for example, ½ pitch, from the state illustrated in FIG. 18(A), the engaging edge 168a completely passes one screw thread 13a of the second male threaded helical structure 15 and then is screwed with a next one of the second male threaded helical structure 15, as illustrated in FIG. 18(C). By repeating such an operation, each time the female threaded body 100 is rotated by 180°, the engaging edge 168a passes the screw thread 13a of the second male threaded helical structure 15 and the female threaded body 100 is, accordingly, fastened to the male threaded body 10. In FIG. 18(C), when the tapered surface 182 of the female threaded body 100 correctly comes into contact with the fastening target member 500, an optimal fastening state may be maintained.

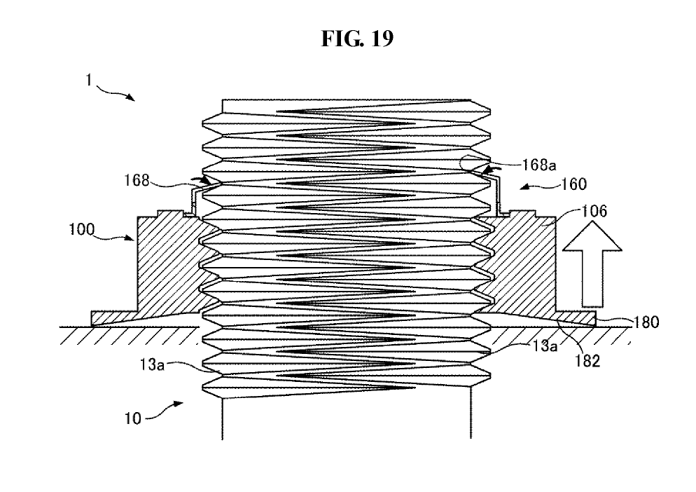

Referring to FIG. 19, under the assumption that the cylindrical member 106 of the female threaded body 100 is to be rotated in a releasing direction in which the cylindrical member 106 is released from the first male threaded helical structure 14 of the male threaded body 10, the protruding portion 168 forms an inclination such that a front end side, for example, a side of the engaging edge 168a, is separated from a virtual plane formed by the contact surface 110a, and such an inclination is set to correspond to, or desirably be contact with, a flank surface of the screw thread 13a of the second male threaded helical structure 15. In addition, a length from a base end of the protruding portion 168, for example, the end edge 165a of the standing portion 165, to a front end, for example, the engaging edge 168a, is set to correspond to, or desirably equal to, a distance from a top to a bottom of the screw thread 13a. Thus, when a relative rotation in a releasing direction is applied to the cylindrical member 106 of the female threaded body 100, an inclined surface of the protruding portion 168 receives a force in a direction in which the inclined surface approaches the virtual plane formed by the contact surface 110a towards the standing portion 165, for example, a direction in which the engaging edge 168a is closer to the contact surface 110a, and is then elastically deformed. By increasing rigidity in a radially outward direction of the standing portion 165, a distance (e.g., a distance in a horizontal direction as illustrated in FIG. 19) in a virtual plane direction of the front end from the base end of the protruding portion 168 increases, and a valley of the screw thread 13a is narrowed by the engaging edge 168a, and thus the relative rotation in the releasing direction may be prevented mechanically and robustly. That is, the engaging edge 168a of the reverse rotation-preventing member 160 enters the thread valley of the screw thread 13a of the second male threaded helical structure 15, and thus controls the relative rotation by crossing or conflicts of the progresses of the cylindrical member 106 and the reverse rotation-preventing member 106. Thus, the male threaded body 10 may not perform the relative rotation in the releasing direction. The reverse rotation-preventing member 160 allows a relative rotation along with the male threaded body 10 in one direction, for example, a fastening direction, by the first female threaded helical structure 114 of the cylindrical member 106, and suspends a reverse rotation completely. In addition, in the female threaded body 100, by setting an extension length or protruding length of the protruding portion 168, setting a standing length of the standing portion 165, and setting a relative angle between the protruding portion 168 and the standing portion 165, it is possible to apply a predetermined or higher amount of a torque in the releasing direction, elastically deform the protruding portion 168, and separate the female threaded body 100 from the male threaded body 10, relatively readily.

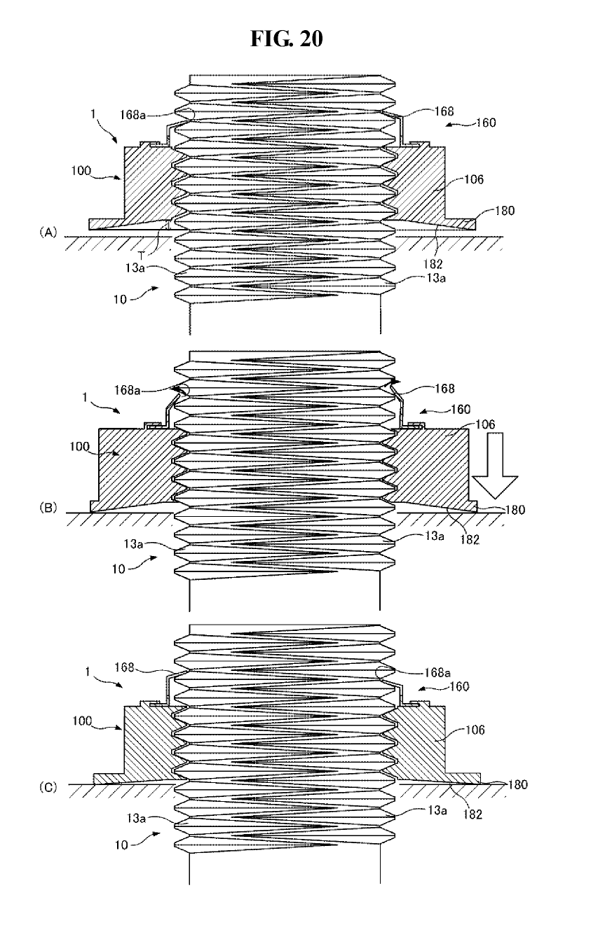

Another fastening example different from the example illustrated in FIG. 18 will be described hereinafter with reference to FIG. 20. As illustrated in FIG. 20(A), while the first female threaded helical structure 114 of the cylindrical member 106 of the female threaded body 100 is being screwed with the first male threaded helical structure 14 of the male threaded body 10, the engaging edge 168a of the reverse rotation-preventing member 160 comes into contact with the second male threaded helical structure 15 of the male threaded body 10. However, since the female threaded body 100 is screwed based on the first female threaded helical structure 114 of the cylindrical member 106, the engaging edge 168a and the screw thread 13a of the second male threaded helical structure 15 come to an interference state while the cylindrical member 106 is proceeding helically.

As illustrated in FIG. 20(B), when the cylindrical member 106 is rotated by 90° and the first female threaded helical structure 114 is screwed with the first male threaded helical structure 14 in such a state, the engaging edge 168a is elastically deformed, along a flank side of the screw thread 13a, in an axial direction and/or radially outward direction in which the engaging edge 168a is separated farther apart from the contact surface 110a, and is to pass the second male threaded helical structure 15, because the engaging edge 168a is inclined in a direction in which the engaging edge 168a is separated farther apart from the seating surface portion 162. However, in this illustrated example, before the engaging edge 168a passes the screw thread 13a completely, the tapered surface 182 of the cylindrical member 106 comes into contact with the fastening target member 500.

In such an example, as illustrated in FIG. 20(C), by re-tightening the cylindrical member 106, the tapered surface 182 is elastically deformed by a reaction force from the fastening target member 500, and the tapered surface 182 is transformed into a plane or flat surface. Previously, the engaging edge 168a completely passes one screw thread 13a of the second male threaded helical structure 15, and then is engaged with a next one of the second male threaded helical structure 15. That is, as illustrated in FIG. 20(B), although the tapered surface 182 of the cylindrical member 106 comes into contact with the fastening target member 500 immediately before the engaging edge 168a passes the screw thread 13a, the tapered surface 182 is elastically deformed, with an axial displacement T of the tapered surface 182, such that the engaging edge 168apasses the screw thread 13a completely while maintaining a fastening force. In addition, as illustrated in FIG. 20(C), by setting a deformed state of the tapered surface 182 to be a final fastening state by the female threaded body 100, it is possible to maintain the fastening force.

Hereinafter, the axial displacement T of the tapered surface 182 of the cylindrical member 106 will be described in detail.

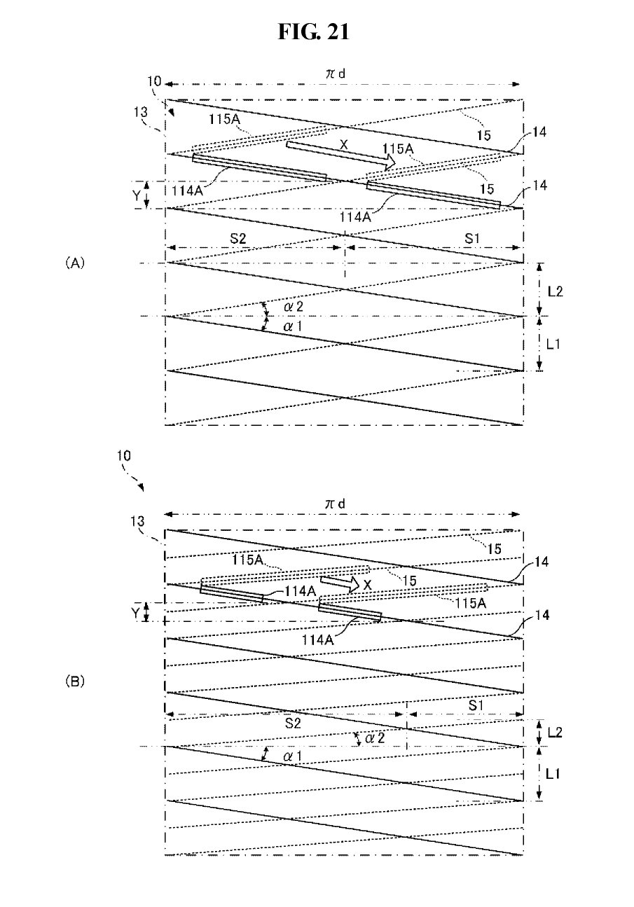

FIG. 21(A) illustrates an outer circumferential surface of a portion of the male threaded portion 13 of the male threaded body 10 that is developed in a plane according to an example embodiment of the present disclosure. In the male threaded portion 13, the first male threaded helical structure 14 and the second male threaded helical structure 15 are formed by overlapping each other. In FIG. 21, a thread valley of the first male threaded helical structure 14 is indicated by a solid line, and a thread valley of the second male threaded helical structure 15 is indicated by a broken line.

In addition, a region obtained by virtually cutting a portion of the first female threaded helical structure 114 that is formed in the cylindrical member 106 is defined as a first female threaded helical region 114A, and a region obtained by virtually cutting a portion of the second female threaded helical structure 115 that is formed in the engaging edge 168a of the reverse rotation-preventing member 160 is defined as a second female threaded helical region 115A. Here, a lead and a lead angle of the first female threaded helical region 114A are referred to as L1 and α1, respectively. A lead and a lead angle of the second female threaded helical region 115A are referred to as L2 and α2, respectively.

The first female threaded helical region 114A and the second female threaded helical region 115A are formed in an integral form in the female threaded body 100, and thus both may not move relatively. When the cylindrical member 106 proceeds helically towards the male threaded body 10, the first female threaded helical region 114A moves along the thread valley of the first male threaded helical structure 14. Concurrently, the second female threaded helical region 115A is also about to move along the second male threaded helical structure 15. However, due to a movement direction (or lead direction) or a movement amount (or lead amount) that is different from that of the first female threaded helical region 114A, the second female threaded helical region 115A is elastically displaced as indicated by an arrow X, and forced to pass the screw thread 13a of the second male threaded helical structure 15 and then move to a next valley.

Here, an axial movement amount of the first female threaded helical region 114A, which is obtained until the second female threaded helical region 115A being in contact with the thread valley of the second male threaded helical structure 15 is forced to pass the screw thread 13a and then move to the next valley, is defined as Y as below.

Y={L1×L2/(L1+L2)}

From the above equation, the following equation is derived. As illustrated in FIG. 21(A), when circumferential lengths to two points at which the first male threaded helical structure 14 and the second male threaded helical structure 15 cross each other are defined as S1 and S2, respectively, Equation 1 is obtained based on respective lead angles α1 and α2.

S1×tan α1=S2×tan α2 [Equation 1]

In Equation 1, when a circumferential distance of a male thread is defined as πd, wherein d denotes a diameter, Equation 2 is obtained as below.

S2=πd−S1 [Equation 2]

By substituting Equation 2 to Equation 1, Equation 3 is obtained as below.

tan α1×S1=tan 2×(πd−S1)

(tan α1+tan α2)×S1=tan α2×πdS1=tan α2×πd/(tan α1+tan α2)

S1×tan α1=tan α1×tan α2×πd/(tan α1+tan α2) [Equation 3]

In Equation 3, ‘S1×tan α1’ corresponds to a current axial movement amount Y, and thus the following final equation is obtained.

Y=tan α1×tan α2×(πd)2/{(tan α1+tan α2)×πd}

Y=L1×L2/(L1+L2)

Thus, when the axial displacement T of the tapered surface 182 is set to be greater than or equal to Y, the second female threaded helical region 115A passes one screw thread 13a of the second male threaded helical structure 15 by the elastic deformation of the tapered surface 182. In actuality, that the second female threaded helical region 115A positioned at a valley of a previous screw thread 13a of the second male threaded helical structure 15 passes a tip of a next screw thread 13a may be a minimum requirement, and thus it may be desirable to set the axial displacement T of the tapered surface 182 to be greater than or equal to half of the axial movement Y. Here, when an extension length of the protruding portion 168 is small, that is, when an amount of engagement between the protruding portion 168 and threads of the male threaded body 10 is small, it may also be desirable that the axial displacement T of the tapered surface 182 is small. Thus, the axial displacement T of the tapered surface 182 is set as below.

T≧(1/2)×{L1×L2/(L1+L2)}, and more desirably,

T≧{L1×L2/(L1+L2)}

According to this example embodiment, the lead amounts of the first female threaded helical region 114A and the second female threaded helical region 115A are equal to each other, and thus L1=L2. Thus, by defining a set value of the axial displacement T of the tapered surface 182 based on L1, the following is obtained.

Y=(1/2)×L1

T≧(1/4)×L1, and more desirably, T≧(1/2)×L1

FIG. 21(B) illustrates an example modification of the example embodiment. Here, the lead L2 of the second female threaded helical region 115A is set to be half of the lead L1 of the first female threaded helical region 114A. In such an example, L2=(1/2)×L1, and the following is obtained by defining a set value of the axial displacement T of the tapered surface 182 based on L1.

Y=(1/3)×L1

T≧(1/6)×L1, and more desirably, T≧(1/3)×L1

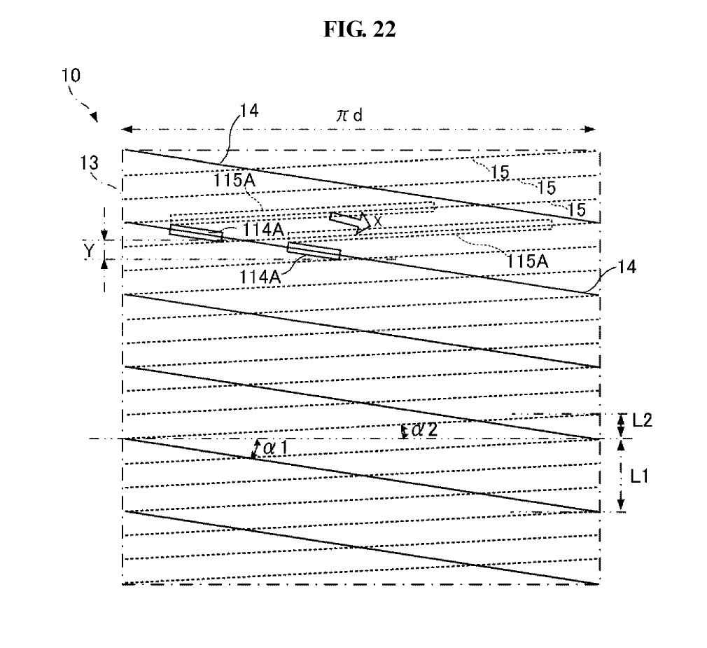

FIG. 22 illustrates an example modification of the example embodiment. Here, the lead L2 of the second female threaded helical region 115A is set to be ⅓ of the lead L1 of the first female threaded helical region 114A. In such an example, L2=(1/3)×L1, and the following is obtained by defining a set value of the axial displacement T of the tapered surface 182 based on L1.

Y=(1/4)×L1

T≧(1/8)×L1, and more desirably, T≧(1/4)×L1

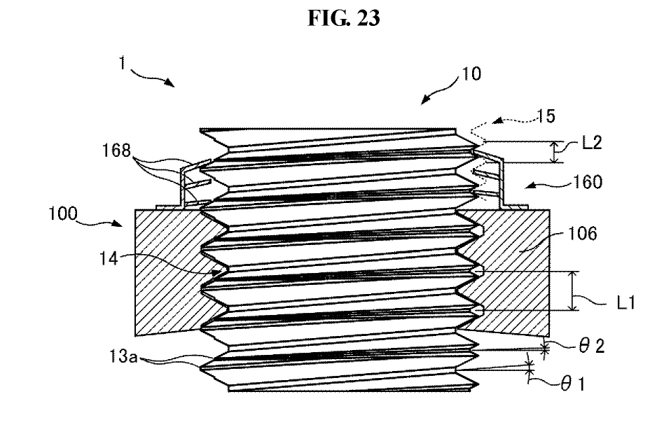

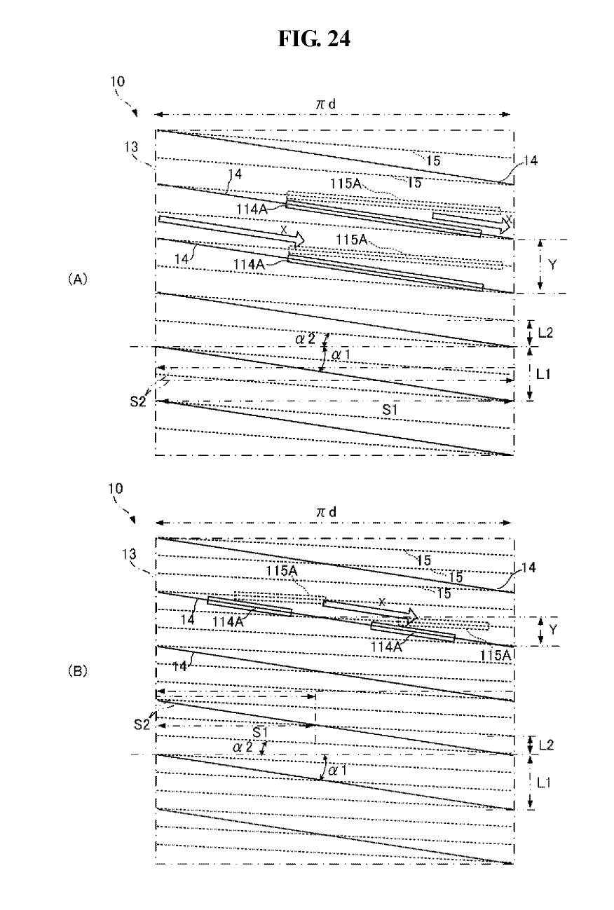

Although, in the male threaded body 10 and the female threaded body 100, the first male threaded helical structure 14 and the first female threaded helical structure 114, and the second male threaded helical structure 15 and the second female threaded helical structure 115 are illustrated as being in a reverse screw relationship, respectively, having the same lead angle and opposite lead directions, example embodiments of the present disclosure are not limited to the example described in the foregoing. For example, as illustrated in FIGS. 23 and 24(A), it is possible to employ the first male threaded helical structure 14 and the first female threaded helical structure 114, and the second male threaded helical structure 15 and the second female threaded helical structure 115, which have the same lead directions L1 and L2, and different lead angles, respectively. In such an example, by overlapping a threaded helix, along with the screw thread 13a formed by the first male threaded helical structure 14, the first male threaded helical structure 14 with the lead L1 (or lead angle α1) and the second male threaded helical structure 15 with the lead L2 (or lead angle α2) are aligned in a screwing direction. Here, a condition, L1>L2, is satisfied.

In such an example, the axial movement amount Y is represented as below, with an application of the relationship S2=πd−S1 as S2−S1=πd.

Y={L1×L2/(L1−L2)}

FIG. 24(A) illustrates an example in which the lead 2 of the second female threaded helical region 115A is set to be half of the lead L1 of the first female threaded helical region 114A, for example, L2=(1/2)×L1. Here, by defining a set value of the axial displacement T of the tapered surface 182 based on L1, the following is obtained.

Y=L1

T≧(1/2)×L1, and more desirably, T≧L1

FIG. 24(B) illustrates an example modification of the example illustrated in FIG. 24(A). Here, the lead L2 of the second female threaded helical region 115A is set to be ⅓ of the lead L1 of the first female threaded helical region 114A. In such an example, by defining a set value of the axial displacement T of the tapered surface 182 based on L1, the following is obtained.

Y=(1/2)×L1

T≧(1/4)×L1, and more desirably, T≧(1/2)×L1

In addition, FIG. 24(B) is a developed view illustrating the example modification of the example illustrated in FIG. 21(A). Here, the second male threaded helical structure 15 is provided as a multi-start thread, for example, a double-start thread herein. In such an example, a pitch P2 of the second male threaded helical structure 15 is defined as P2=(1/2)×L2. In such an example, the second male threaded helical structure 15 is a multi-start thread, and thus the axial movement amount Y is defined to be small as below.

Y={L1×P2/(L1+P2)}

Thus, the axial displacement T of the tapered surface 182 is set as below.

T≧(1/2)×{L1×P2/(L1+P2)}, and more desirably,

T≧{L1×P2/(L1+P2)}

In the example modification, the lead amounts of the first female threaded helical region 114A and the second female threaded helical region 115A are equal to each other, for example, L1=L2. Thus, by defining a set value of the axial displacement T of the tapered surface 182 based on L1, the following is obtained.

Y=(1/4)×L1

T≧(1/8)×L1, and more desirably, T≧(1/4)×L1

Although not illustrated, in a case of the first male threaded helical structure 14 being a multi-start thread, it may also be desirable to apply the pitch P1 of the first male threaded helical structure 14, in lieu of the lead L1. Here, a value of Y is defined as below.

Y={P1×L2/(P1+L2)}

In a case in which both the first male threaded helical structure 14 and the second male threaded helical structure 15 are multi-start threads, it may also be desirable to apply the pitches P1 and P2 in lieu of the leads L1 and L2. Here, a value of Y is defined as below.

Y={P1×P2/(P1+P2)}

In addition, in a case in which both the leads of the first male threaded helical structure 14 and the second male threaded helical structure 15 are the same, the following is obtained. Here, a condition, P1>P2, is satisfied.

Y={P1×P2/(P1−P2)}

As described above, in the female threaded body 100, there is an inconsistency between a timing at which the cylindrical member 106 initially comes into contact with the fastening target member 500 and a timing at which the engaging edge 168a passes the screw thread 13a of the second male threaded helical structure 15. According to this example embodiment, the tapered surface 182 is formed at an axial end of the cylindrical member 106. The tapered surface 182 is provided in a conically trapezoidal form or a curved form, in which a radially inner side is recessed in an axial direction, and thus the tapered surface 182 is elastically deformed to be closer to a flat surface perpendicular to an axis when receiving a reaction force from the fastening target member 500 by a fastening force. A relative rotation of the cylindrical member 106 may be enabled by an amount of the axial displacement T of the tapered surface 182, or an amount of the elastic deformation of the tapered surface 182. Thus, the engaging edge 168a may pass the screw thread 13a of the second male threaded helical structure 15. Thus, by the female threaded body 100 according to this example embodiment, it is possible to prevent a reverse rotation, and also to maintain a high fastening force of the fastening target member 500.

In particular, in a case in which the lead directions of the first female threaded helical structure 114 and the second female threaded helical structure 115 are opposite to each other, the axial displacement T of the tapered surface 182 is set to be T≧(1/2)×{L1×L2/(L1+L2)} and, more desirably, T≧{L1×L2/(L1+L2)}. In a case in which the tapering directions of the first female threaded helical structure 114 and the second female threaded helical structure 115 are equal to each other, the axial displacement T is set to be T≧(1/2)×{L1×L2/(L1−L2)} and, more desirably, T≧{L1×L2/(L1−L2)}. In addition, in a case in which the second male threaded helical structure 15 that is screwed with the second female threaded helical structure 115 is a multi-start thread, by changing the lead L2 to the pitch P2, the axial displacement T is set to be T≧(1/2)×{L1×P2/(L1+P2)} and, more desirably, T≧{L1×P2/(L1+LP)} or T≧(1/2)×{L1×P2/(L1−P2)} and, more desirably, T≧{L1×P2/(L1−P2)}. By setting the axial displacement T as described above, it is possible to prevent a shortage of the axial displacement T of the tapered surface 182.

In addition, by the female threaded body 100 according to this example embodiment, when observing a range including the contact surface 110a of the receiving portion 110 from a cross-sectional viewpoint perpendicular to an axis, a cross-sectional shape of the contact surface 110a may be observed as being formed at a plurality of positions in a circumferential direction and/or formed in an annular shape. Thus, a posture of the reverse rotation-preventing member 160 being held and maintained by the contact surface 110a may be stabilized, and thus assembling may be performed more readily and also a precision in the assembling may be improved. In addition, according to this example embodiment, the cross-sectional shape of the contact surface 110a is the annular shape, or a ring shape, and thus an optimally stable state may be achieved.

According to this example embodiment, in an end surface of the cylindrical member 106, when the contact surface 110a is formed as a plane or a flat surface perpendicular to a rotation axis, it is possible to mass produce the cylindrical member 106, as in a nut, in a simple manner when forming the cylindrical member 106 through pressing, cutting, rolling, heading, molding, shaping, and the like. In addition, to form the contact surface 110a to be inclined in an axially perpendicular direction and form a lead angle or a lead direction of the engaging edge 168a to be a slope in a set circumferential direction using such formed contact surface 110a, a production cost of the cylindrical member 106 may increase. Further, when observing a range including the contact surface 110a of such a slope type from a cross-sectional view point perpendicular to an axis, a cross-sectional shape of the contact surface 110a may be observed as being formed at only one position in a circumferential direction. Due to this, a posture of the reverse rotation-preventing member 160 being held and maintained by the contact surface 110a may not be stable, and a force of sliding, along the slope, the reverse rotation-preventing member 160 in a circumferential direction may be readily generated. Thus, when assembling the cylindrical member 106 and the reverse rotation-preventing member 160, a high precision in determining a position may be needed.

In addition, according to this example embodiment, by the standing portion 165 with an axial-direction extension distance J that increases gradually along a circumferential direction, a lead direction and a lead angle of the second female threaded helical structure 115 are set. By employing such a structure, a mass production of the reverse rotation-preventing member 160 may be enabled and a production cost thereof may be reduced considerably through, for example, press molding using a plate-type member.

Further, in the female threaded body 100, by the first circumferential engaging portion 120 of the cylindrical member 106 and the second circumferential engaging portion 162a of the reverse rotation-preventing member 160, although not necessarily, the cylindrical member 106 and the reverse rotation-preventing member 160 may be fixed in a circumferential direction. Thus, it is possible to control a relative rotation of the cylindrical member 106 and the reverse rotation-preventing member 160 even when being forced to be fastened together while being interfered by the engaging edge 168a of the reverse rotation-preventing member 160.

In addition, by the first axial engaging portion 130 of the cylindrical member 106 and the second axial engaging portion 162b of the reverse rotation-preventing member 160, the cylindrical member 106 and the reverse rotation-preventing member 160 may be fixed in an axial direction. Thus, it is possible to prevent the cylindrical member 106 and the reverse rotation-preventing member 160 from deviating in the axial direction even when the cylindrical member 106 is forcibly screwed and the engaging edge 168a of the reverse rotation-preventing member 160 is displaced in a radial direction. According to this example embodiment, a caulking may be performed by bending the first axial engaging portion 130 when being assembled, and thus both may be integrated with each other despite a simple and easy production process.

In particular, according to this example embodiment, the seating surface portion 162 of the reverse rotation preventing apparatus 160 is in contact with the contact surface 110a of the receiving portion 110 in an angle range of at least 180° or greater in a circumferential direction. As described, by setting the seating surface portion 162 to be in an angle range of 180° or greater, it may not be easy to deviate from a state of being engaged with the first axial engaging portion 130 even when an external force is applied to the reverse rotation-preventing member 160. In addition, through the contact with the male threaded body 10 in an angle range of 180° or less in a circumferential direction, the engaging edge 168a of the reverse rotation-preventing member 160 may be displaced, flexibly and readily, in an axial direction and/or a radially outward direction. That is, the reverse rotation-preventing member 160 according to this example embodiment may be completely integrated with the cylindrical member 106, and allow the engaging edge 168a to be easily displaced. Here, by disposing a plurality of engaging edges 168a as the engaging edge 168a in a circumferential direction, the engaging edges 168a may be engaged with the male threaded body 10 when the female threaded body 100 is rotated in a releasing direction, and control such a rotation. In addition, by setting an angle between the engaging edge 168a and the standing portion 165 to be an obtuse angle, the engaging edge 168a may be elastically deformed in an axial direction in which the engaging edge 168a is separated farther apart from the standing portion 165, for example, a direction in which the angle between both is closer to 180°. However, an elastic deformation in an axial direction in which the engaging edge 168a is closer to the standing portion 165, for example, a direction in which the angle between both is closer to 90°, may not be easy.

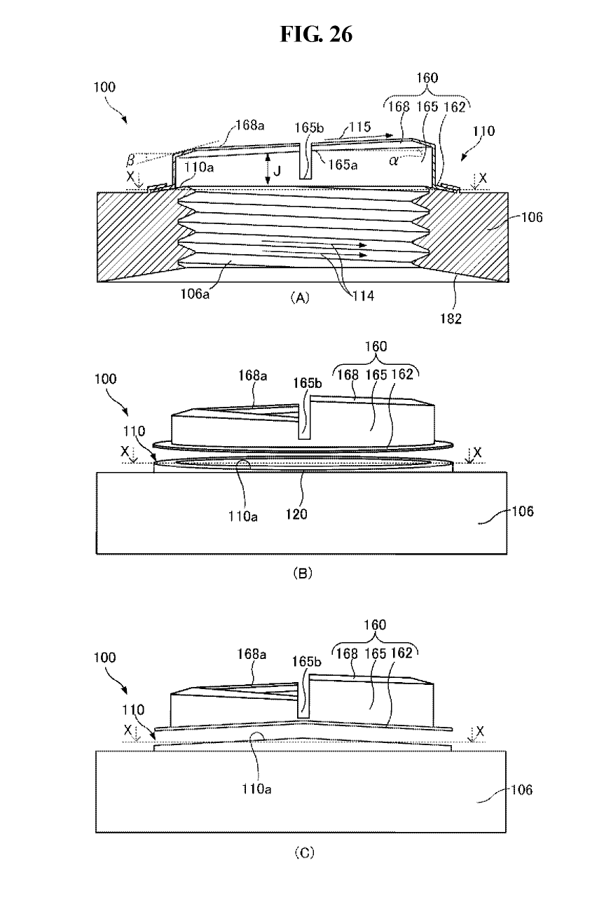

Although, in the female threaded body 100 according to this example embodiment, a cross-sectional shape of a range including the contact surface 110a that is observed perpendicular to an axis is illustrated as a planar ring form that corresponds to the contact surface 110a, example embodiments of the present disclosure are not limited to the example described in the foregoing. For example, as shown in the female threaded body 100 illustrated in FIG. 26(A), the contact surface 110a is provided as a tapered surface that is inclined in a radial direction. In such an example, an X-X cross-sectional shape perpendicular to an axis may be an annular line. For another example, as shown in the female threaded body 100 illustrated in FIG. 26(B), the contact surface 110a is provided as an inclined surface which is inclined in one direction with respect to an axis. In such an example, an X-X cross-sectional shape perpendicular to the axis may be two linear portions. For still another example, as shown in the female threaded body 100 illustrated in FIG. 26(C), the contact surface 110a is provided as a pair of inclined surfaces that is inclined in one direction and the other direction with respect to an axis. In such an example, an X-X cross-sectional shape of the contact surface 110a that is perpendicular to the axis may be four linear portions. In any examples, when observing the contact surface 110a from a cross-sectional viewpoint perpendicular to an axis, a cross-sectional shape may be observed as being formed at a plurality of positions in a circumferential direction, and thus a posture of the reverse rotation-preventing member 160 being held and maintained may be stabilized.

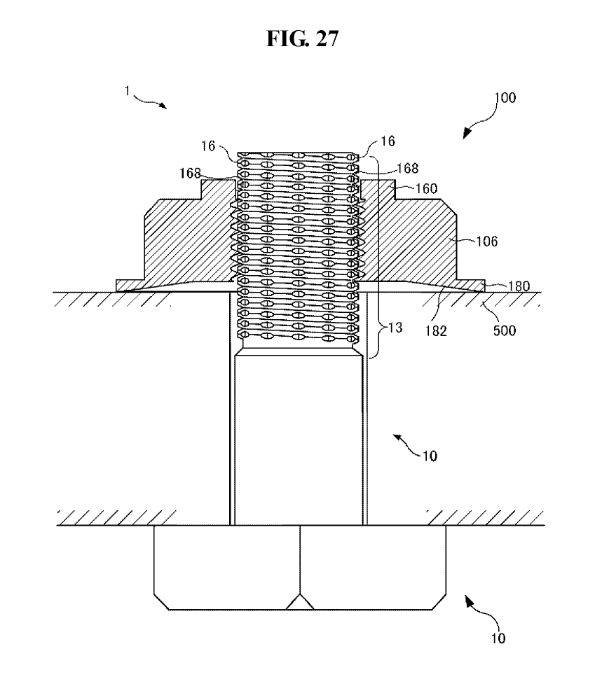

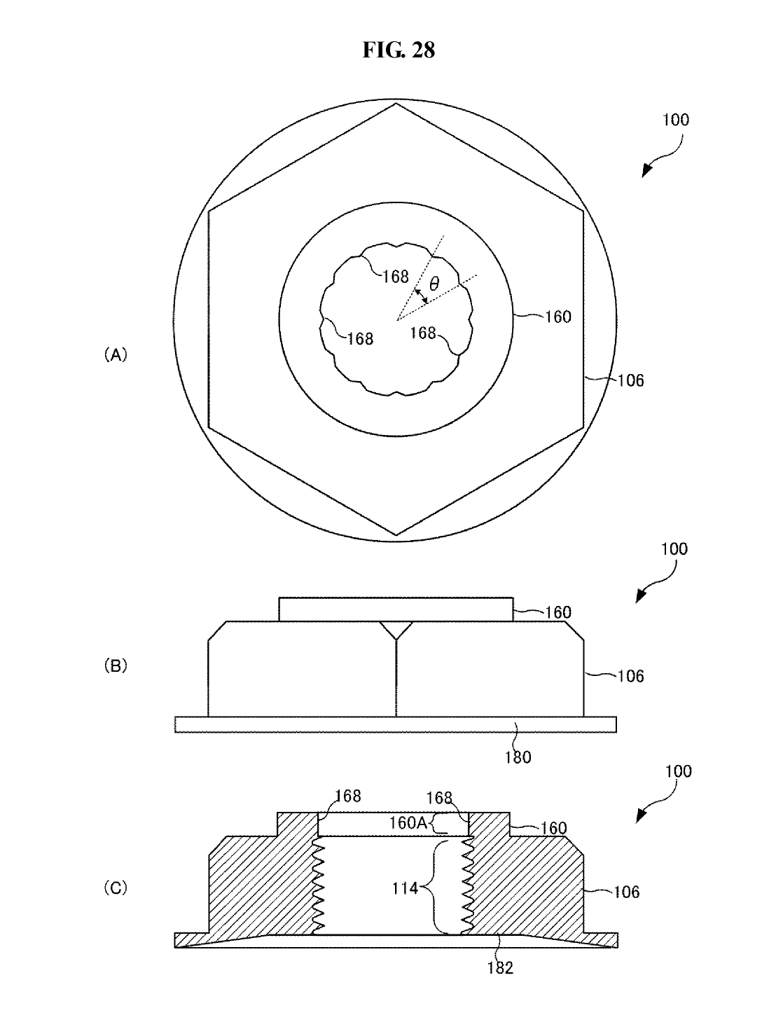

Although, according to this example embodiment, two different types of the helical structures 14 and 15 are formed in the male threaded body 10 to prevent a reverse rotation of the female threaded body 100, example embodiments of the present disclosure are not limited to the example described in the foregoing. FIGS. 27 and 28 illustrate another fastening structure. In this fastening structure, a male threaded portion 13 of a male threaded body 10 includes a single first male threaded helical structure 14 and a male thread-side contact portion 16, which is provided at 12 positions at equidistant intervals in a circumferential direction that is recessed in a radially inward direction. Although the male thread-side contact portion 16 is illustrated as overlapping the first male threaded helical structure 14, it may also be desirable to form the male thread-side contact portion 16 not to overlap an axial end portion. It may also be desirable to form the male threaded-side contact portion 16 to be within a necessary area of the first male threaded helical structure 14.

In the female threaded body 100, a reverse rotation-preventing region 160A that is in a cross-sectional non-circular shape when observed in an axial direction is formed in a reverse rotation-preventing member 160 that is integrally formed with a cylindrical member 106. Although the reverse rotation-preventing region 160A is illustrated as protruding, in a ring shape, in an axial direction on a side opposite to a tapered surface 182 of the cylindrical member 106, it may also be desirable to provide the reverse rotation-preventing region 160A on a side of the tapered surface 182, and to form the reverse rotation preventing-region 160A to overlap the male threaded portion 13.

In the reverse rotation-preventing region 160A, a female thread-side protruding portion 168 that is convex in a radially inward direction is formed at 12 positions in a circumferential direction at equidistant intervals. Thus, the female thread-side protruding portion 168 is engaged with the male thread-side contact portion 16, which is formed in the male threaded portion 13 of the male threaded body 10 by being recessed, in a circumferential direction at 30° intervals. As described above, the reverse rotation-preventing region 160A is provided as having a thin thickness in an axial direction, and is thus to be elastically deformed in a radially outward direction. Thus, by relatively rotating the male threaded body 10 and the female threaded body 100 with a desired force, the reverse rotation preventing-region 160A is elastically deformed outwards, and a circumferential-direction engagement with the male thread-side contact portion 16 is released. Thus, by applying a desired force to the male threaded body 10 and the female threaded body 100 in a tightening, or fastening, direction, the engagement and the releasing between the male thread-side contact portion 16 and the female thread-side protruding portion 168 repeat to allow a relative rotation, and thus it is possible to fix the female threaded body 100 to an arbitrary position of the male threaded portion 13. More desirably, by providing at least one of the male thread-side contact portion 16 and the female thread-side protruding portion 168 to be in a sawteeth shape, it may function as, for example, a ratchet that allows a rotation in a tightening, or fastening, direction and controls a rotation in a releasing direction.

In such a fastening structure, when a circumferential-direction angle set to be 30° is referred to as θ and a lead of a first female threaded helical structure 114 is referred to as L1, an axial displacement T of the tapered surface 182 is set as below.

T≧L1×(θ/360)

Here, although, when fastening, the tapered surface 182 comes into contact with a fastening target member 500, a member to be fastened, at a timing at which the engagement between the male thread-side contact portion 16 and the female thread-side protruding portion 168 is released, it is possible to rotate the female threaded body 100 by the axial displacement T and also engage the male thread-side contact portion 16 and the female thread-side protruding portion 168.

Although, according to this example embodiment, the female threaded body 100 is illustrated as including a tapered surface, it is also possible to form such a tapered surface on a side of a head portion of the male threaded body 10. In addition, it is also possible to form tapered surfaces on both the female threaded body 100 and the male threaded body 10. In such a case, the axial displacement T may be a sum of such amounts from the tapered surfaces of both.

Although a few example embodiments of the present disclosure have been shown and described, the present disclosure is not limited to the described example embodiments. Instead, it would be appreciated by those skilled in the art that changes may be made to these example embodiments without departing from the principles and spirit of the present disclosure, the scope of which is defined by the claims and their equivalents.

### DESCRIPTION OF REFERENCE NUMERALS

1 Fastening structure

10 Male threaded body

13 Male threaded portion

14 First male threaded helical structure

15 Second male threaded helical structure

100 Female threaded body

106 Cylindrical member

110 Receiving portion

110a Contact surface

114 First female threaded helical structure

115 Second female threaded helical structure

120 First circumferential engaging portion

130 First axial engaging portion

160 Reverse rotation-preventing member

162 Seating surface portion

162a Second circumferential engaging portion

162b Second axial engaging portion

165 Standing portion

168 Protruding portion

168a Engaging edge

180 Rim

182 Tapered surface

1. A female threaded body comprising:
a female threaded helical structure formed on an inner circumferential surface of a hole of a cylindrical member and set at a lead angle and/or in a lead direction;
a receiving portion including a contact surface formed on an end surface of the cylindrical member in an axial direction of the hole; and
a reverse rotation-preventing member disposed on the contact surface and including a protruding portion extended in a radially inward direction towards an axis, wherein a protruding end of the protruding portion includes a disconnected or connected helical engaging edge that is set at a lead angle and/or in a lead direction different from the lead angle and/or the lead direction of the female threaded helical structure,
wherein the engaging edge is elastically deformed to rotate on a base end of the protruding portion as a supporting point in a direction in which the protruding end is separated from the contact surface, and is elastically deformed repetitively to helically proceed when being screwed with a male thread to allow a relative rotation of the female threaded helical structure in one direction and prevent a relative rotation of the female threaded helical structure in another direction.

2. The female threaded body of claim 1, wherein, when observing the contact surface from a cross-sectional viewpoint in a direction perpendicular to the axis, a cross-sectional shape of the contact surface is observed at a plurality of positions in a circumferential direction of the axis and/or the cross-sectional shape is observed as being formed in an annular shape.

3. The female threaded body of claim 1, wherein the receiving portion includes a first circumferential engaging portion, and
the reverse rotation-preventing member includes a second circumferential engaging portion that is engaged with the first circumferential engaging portion in a circumferential direction,
wherein, by the first circumferential engaging portion and the second circumferential engaging portion, the cylindrical member and the reverse rotation-preventing member are fixed in the circumferential direction.

4. The female threaded body of claim 1, wherein the receiving portion includes a first axial engaging portion, and
the reverse rotation-preventing member includes a second axial engaging portion that is engaged with the first axial engaging portion in an axial direction,
wherein, by the first axial engaging portion and the second axial engaging portion, the cylindrical member and the reverse rotation-preventing member are fixed in the axial direction.

5. The female threaded body of claim 4, wherein the first axial engaging portion is engaged with the reverse rotation-preventing member in the axial direction by being bent when being assembled.

6. The female threaded body of claim 4, wherein the first axial engaging portion is formed along an outer circumference of the reverse rotation-preventing member.

7. The female threaded body of claim 1, wherein the reverse rotation-preventing member includes the engaging edge in a range of less than 360° in a circumferential direction, which is provided as a plurality of engaging edges in the circumferential direction.

8. The female threaded body of claim 1, wherein the reverse rotation-preventing member comprises:
a seating surface portion being in contact with the contact surface of the receiving portion; and
a standing portion extended from the seating surface portion in an axial direction, an extension distance in the axial direction gradually increasing in a circumferential direction,
wherein the protruding portion is extended in a radially inward direction from the standing portion.

9. A female threaded body comprising:
a first female threaded helical structure formed on an inner circumferential surface of a hole of a cylindrical member, and set at a lead angle and/or in a lead direction;
a reverse rotation-preventing member disposed in the cylindrical member, including a protruding portion extended in a radially inward direction towards an axis of the hole, and configured to prevent a rotation by the first female threaded helical structure at a predetermined circumferential angle by a protruding end of the protruding portion; and
a deformable tapered surface formed on an end surface on another side of the cylindrical member,
wherein, when being in contact with a male thread and elastically deformed, the protruding potion allows a relative rotation of the first female helical structure and the male thread in one direction and prevents a relative rotation of the first female threaded helical structure and the male thread in another direction to control a reverse rotation.

10. The female threaded body of claim 9, wherein, when a lead of the first female threaded helical structure is referred to as L1 and the predetermined circumferential angle is referred to as θ, an axial displacement T by a deformation of the tapered surface satisfies T≧L1×(θ/360).

11. The female threaded body of claim 9, wherein the reverse rotation-preventing member includes a disconnected or connected second female threaded helical structure at the protruding end of the protruding portion, the second female threaded helical structure set in a lead direction different from the lead direction of the first female threaded helical structure,
wherein, when a lead of the first female threaded helical structure is referred to as L1 and a lead of the second female threaded helical structure is referred to as L2, an axial displacement T by a deformation of the tapered surface satisfies T≧(1/2)×{L1×L2/(L1+L2)}.

12. The female threaded body of claim 11, wherein the axial displacement T on the tapered surface satisfies T≧{L1×L2/(L1+L2)}.

13. The female threaded body of claim 9, wherein the reverse rotation-preventing member includes a disconnected or connected second female threaded helical structure at the protruding end of the protruding portion, the second female threaded helical structure set in a lead direction different from the lead direction of the first female threaded helical structure,
wherein, when a lead of the first female threaded helical structure is referred to as L1 and a lead of the second female threaded helical structure is referred to as L2, an axial displacement T by a deformation of the tapered surface satisfies T≧(1/2)×{L1×L2/(L1−L2)}.

14. The female threaded body of claim 13, wherein the axial displacement T by the deformation of the tapered surface satisfies T≧{L1×L2/(L1−L2)}.

15. The female threaded body of claim 9, wherein the reverse rotation-preventing member includes a disconnected or connected second female threaded helical structure at the protruding end of the protruding portion, the second female threaded helical structure set in a lead direction different from the lead direction of the first female threaded helical structure,
wherein, when a lead of the first female threaded helical structure is referred to as L1 and a pitch of the second female threaded helical structure is referred to as P2, an axial displacement T by a deformation of the tapered surface satisfies T≧(1/2)×{L1×P2/(L1+P2)}.

16. The female threaded body of claim 9, wherein the reverse rotation-preventing member includes a disconnected or connected second female threaded helical structure at the protruding end of the protruding portion, the second female threaded helical structure set in a lead direction different from the lead direction of the first female threaded helical structure,
wherein, when a lead of the first female threaded helical structure is referred to as L1 and a pitch of the second female threaded helical structure is referred to as P2, an axial displacement T by a deformation of the tapered surface satisfies T≧(1/2)×{L1×P2/(L1−P2)}.

17. A threaded body fastening structure comprising:
a male threaded body; and
a female threaded body to be screwed with the male threaded body,
wherein the male threaded body comprises:
a head portion; and
an axis portion including a first male threaded helical structure set at a lead angle and/or in a lead direction, and
the female threaded body comprises:
a first female threaded helical structure formed on an inner circumferential surface of a hole of a cylindrical member and set at a lead angle and/or in a lead direction to be screwed with the first male threaded helical structure; and
a reverse rotation-preventing member disposed in the cylindrical member, including a protruding portion extended in a radially inward direction towards an axis, and configured to prevent a rotation by the first female threaded helical structure at a predetermined circumferential angle by a protruding end of the protruding portion,
wherein a deformable tapered surface is formed on an end surface of the head portion of the male threaded body and/or an end surface of the cylindrical member of the female threaded body, and
an engaging edge of the female threaded body comes into contact with the male threaded body and is elastically displaced to allow a relative rotation of the first male threaded helical structure and the first female threaded helical structure in one direction and prevent a relative rotation of the first male threaded helical structure and the first female threaded helical structure in another direction to control a reverse rotation.

18. (canceled)

19. The threaded body fastening structure of claim 17, wherein the axis portion of the male threaded body includes a second male threaded helical structure set at a lead angle and/or in a lead direction different from the lead angle and/or the lead direction of the first male threaded helical structure, and the reverse rotation-preventing member of the female threaded body includes the engaging edge of a second female threaded helical structure at the protruding end of the protruding portion to be screwed with the second male threaded helical structure connectedly or disconnectedly.

20. The female threaded body of claim 9, wherein a lead direction of the engaging edge of a helical shape of the reverse rotation-preventing member is different from the lead direction of the female threaded helical structure.

21. The female threaded body of claim 9, wherein the reverse rotation-preventing member is provided in a contact surface formed on an end surface of the cylindrical member in an axial direction of the hole, and
the protruding end of the protruding portion is elastically deformed to rotate on a base end of the protruding portion as a supporting point in a direction in which the protruding end is separated from the contact surface.
